(19) United States
(12) Patent Application Publication
(10) Pub. No.: US 2022/0254355 A1
(43) Pub. Date: Aug. 11, 2022

(54) MASA with Embedded Near-Far Stereo for Mobile Devices

(71) Applicant: Nokia Technplogies Oy, Espoo (FI)

(72) Inventors: Lasse LAAKSONEN, Tampere (FI); Anssi RAMO, Tampere (FI)

(21) Appl. No.: 17/597,603

(22) PCT Filed: Jul. 21, 2020
(86) PCT No.: PCT/EP2020/070534

§ 371 Date: Jan. 13, 2022

(30) Foreign Application Priority Data
Aug. 2, 2019 (GB) 1911084.0

(51) Int. Cl. G10L 19/008; H04S 3/00; H04S 7/00; G10L 19/24; G10L 19/16

(52) U.S. Cl. CPC G10L 19/008; H04S 3/008; H04S 7/30; H04S 2400/15; G10L 19/167; H04S 2400/11; H04S 2400/01; G10L 19/24

(57) ABSTRACT

An apparatus including circuitry, including at least one processor and at least one memory, configured to: receive at least one channel voice audio signal and metadata, the at least one channel voice audio signal and metadata generated from at least one microphone audio signal; and receive at least one channel ambience audio signal and metadata, wherein the at least one channel ambience audio signal and metadata are generated based on a parametric analysis of at least one microphone audio signal, and the at least one channel ambience audio signal is associated with the at least one channel voice audio signal; generate an encoded multichannel audio signal based on the at least one channel voice audio signal and metadata and further the at least one channel ambience audio signal and metadata.

### FIELD

The present application relates to apparatus and methods for spatial audio capture for mobiles devices and associated rendering, but not exclusively for immersive voice and audio services (IVAS) codec and metadata-assisted spatial audio (MASA) with embedded near-far stereo for mobile devices.

### BACKGROUND

Immersive audio codecs are being implemented supporting a multitude of operating points ranging from a low bit rate operation to transparency. An example of such a codec is the immersive voice and audio services (IVAS) codec which is being designed to be suitable for use over a communications network such as a 3GPP 4G/5G network. Such immersive services include uses for example in immersive voice and audio for applications such as immersive communications, virtual reality (VR), augmented reality (AR) and mixed reality (MR). This audio codec is expected to handle the encoding, decoding and rendering of speech, music and generic audio. It is furthermore expected to support channel-based audio and scene-based audio inputs including spatial information about the sound field and sound sources. The codec is also expected to operate with low latency to enable conversational services as well as support high error robustness under various transmission conditions.

The input signals are presented to the IVAS encoder in one of the supported formats (and in some allowed combinations of the formats). Similarly, it is expected that the decoder can output the audio in a number of supported formats.

Some input formats of interest are metadata-assisted spatial audio (MASA), object-based audio, and particularly the combination of MASA and at least one object. Metadata-assisted spatial audio (MASA) is a parametric spatial audio format and representation. It can be considered a representation consisting of ‘N channels+spatial metadata’. It is a scene-based audio format particularly suited for spatial audio capture on practical devices, such as smartphones. The idea is to describe the sound scene in terms of time- and frequency-varying sound source directions. Where no directional sound source is detected, the audio is described as diffuse. The spatial metadata is described relative to the at least one direction indicated for each time-frequency (TF) tile and can include, for example, spatial metadata for each direction and spatial metadata that is independent of the number of directions.

### SUMMARY

There is provided according to a first aspect an apparatus comprising means

configured to: receive at least one channel voice audio signal and metadata associated with the at least one channel voice audio signal, the at least one channel voice audio signal and metadata generated from at least one microphone audio signal; receive at least one channel ambience audio signal and metadata associated with the at least one channel ambience audio signal, wherein the at least one channel ambience audio signal and metadata are generated based on a parametric analysis of at least one microphone audio signal, and the at least one channel ambience audio signal is associated with the at least one channel voice audio signal; and generate an encoded multichannel audio signal based on the at least one channel voice audio signal and metadata and further the at least one channel ambience audio signal and metadata, such that the encoded multichannel audio signal enables the spatial presentation of the at least one channel voice audio signal spatially independent of the at least one channel ambience audio signal.

The means may be further configured to receive at least one further audio object audio signal, wherein the means configured to generate an encoded multichannel audio signal is configured to generate the encoded multichannel audio signal further based on the at least one further audio object audio signal such that the encoded multichannel audio signal enables the spatial presentation of the at least one further audio object audio signal spatially independent of the at least one channel voice audio signal and the at least one channel ambience audio signal.

The at least one microphone audio signal from which is generated the at least one channel voice audio signal and metadata; and the at least one microphone audio signal from which is generated the at least one channel ambience audio signal and metadata may comprise: separate groups of microphones with no microphones in common; or groups of microphones with at least one microphone in common.

The means may be further configured to receive an input configured to control the generation of the encoded multichannel audio signal.

The means may be further configured to modify a position parameter of the metadata associated with the at least one channel voice audio signal or change a near-channel rendering-channel allocation associated with the at least one channel voice audio signal based on a determined mismatch between the position parameter of the metadata associated with the at least one channel voice audio signal and an allocated near-channel rendering-channel channel.

The means configured to generate an encoded multichannel audio signal based on the at least one channel voice audio signal and metadata and further the at least one channel ambience audio signal and metadata may be configured to: obtain an encoder bit rate; select embedded coding levels and allocate a bit rate to each of the selected embedded coding levels, wherein a first level is associated with the at least one channel voice audio signal and metadata, a second level is associated with the at least one channel ambience audio signal, and a third level is associated with the metadata associated with the at least one channel ambience audio signal; encode at least one channel voice audio signal and metadata, the at least one channel ambience audio signal and metadata associated with the at least one channel ambience audio signal based on the allocated bit rates.

The means may further be configured to determine a capability parameter, the capability parameter being determined based on at least one of: a transmission channel capacity; a rendering apparatus capacity, wherein the means configured to generate an encoded multichannel audio signal may be configured to generate an encoded multichannel audio signal further based on the capability parameter.

The means configured to generate an encoded multichannel audio signal further based on the capability parameter may be configured to select embedded coding levels and allocate a bit rate to each of the selected embedded coding levels based on at least one of the at least one of the transmission channel capacity and the rendering apparatus capacity.

The at least one microphone audio signal used to generate the at least one channel ambience audio signal and metadata based on a parametric analysis may comprise at least two microphone audio signals.

The means may be further configured to output the encoded multichannel audio signal.

According to a second aspect there is provided an apparatus comprising means configured to: receive an embedded encoded audio signal, the embedded encoded audio signal comprising at least one of the following levels of embedded audio signal: at least one channel voice audio signal and associated metadata to be rendered as a spatial voice scene; at least one channel voice audio signal and associated metadata , and at least one channel ambience audio signal to be rendered as a near-far stereo scene; at least one channel voice audio signal and associated metadata, and at least one channel ambience audio signal and associated spatial metadata to be rendered as a spatial audio scene; and decode the embedded encoded audio signal and output a multichannel audio signal representing the scene and such that the multichannel audio signal enables the spatial presentation of the at least one channel voice audio signal independent of the at least one channel ambience channel audio signal.

The levels of embedded audio signal may further comprise at least one channel voice audio signal and associated metadata, and at least one channel ambience audio signal and associated spatial metadata to be rendered as a spatial audio scene and at least one further audio object audio signal and associated metadata and wherein the means configured to decode the embedded encoded audio signal and output a multichannel audio signal representing the scene may be configured to decode and output a multichannel audio signal, such that the spatial presentation of the at least one further audio object audio signal is spatially independent of the at least one channel voice audio signal and the at least one channel ambience audio signal.

The means may be further configured to receive an input configured to control the decoding of the embedded encoded audio signal and output of the multichannel audio signal.

The input may comprise a switch of capability wherein the means configured to decode the embedded encoded audio signal and output a multichannel audio signal may be configured to update the decoding and outputting based on the switch of capability.

The switch of capability may comprise at least one of: a determination of earbud/earphone configuration; a determination of headphone configuration; and a determination of speaker output configuration.

The input may comprise a determination of a change of embedded level wherein the means configured to decode the embedded encoded audio signal and output a multichannel audio signal may be configured to update the decoding and outputting based on the change of embedded level.

The input may comprise a determination of a change of bit rate for the embedded level wherein the means configured to decode the embedded encoded audio signal and output a multichannel audio signal may be configured to update the decoding and outputting based on the change of bit rate for the embedded level.

The means may be configured to control the decoding of the embedded encoded audio signal and output of the multichannel audio signal to modify at least one channel voice audio signal position or change a near-channel rendering-channel allocation associated with the at least one channel voice audio signal based on a determined mismatch between at least one voice audio signal detected position and/or an allocated near-channel rendering-channel channel.

The input may comprise a determination of correlation between the at least one channel voice audio signal and the at least one channel ambience audio signal, and the means configured to decode and output a multichannel audio signal is configured to: when the correlation is less than a determined threshold then: control a position associated with the at least one channel voice audio signal, and control an ambient spatial scene formed by the at least one channel ambience audio signal by rotating the ambient spatial scene, based on the at least one channel ambience audio signal, according to an obtained rotation parameter or compensating for a rotation of the further device by applying a corresponding opposite rotation to the ambient spatial scene; and when the correlation is greater than or equal to the determined threshold then: control a position associated with the at least one channel voice audio signal, and control an ambient spatial scene formed by the at least one channel ambience audio signal by compensating for a rotation of the further device by applying a corresponding opposite rotation to the ambient spatial scene while letting the rest of the scene rotate or rotating the ambient spatial scene, based on the at least one channel ambience audio signal, according to an obtained rotation parameter.

According to a third aspect there is provided a method comprising receiving at least one channel voice audio signal and metadata associated with the at least one channel voice audio signal, the at least one channel voice audio signal and metadata generated from at least one microphone audio signal; receiving at least one channel ambience audio signal and metadata associated with the at least one channel ambience audio signal, wherein the at least one channel ambience audio signal and metadata are generated based on a parametric analysis of at least one microphone audio signal, and the at least one channel ambience audio signal is associated with the at least one channel voice audio signal; and generating an encoded multichannel audio signal based on the at least one channel voice audio signal and metadata and further the at least one channel ambience audio signal and metadata, such that the encoded multichannel audio signal enables the spatial presentation of the at least one channel voice audio signal spatially independent of the at least one channel ambience audio signal.

The method may further comprise receiving at least one further audio object audio signal, wherein generating an encoded multichannel audio signal comprises generating the encoded multichannel audio signal further based on the at least one further audio object audio signal such that the encoded multichannel audio signal enables the spatial presentation of the at least one further audio object audio signal spatially independent of the at least one channel voice audio signal and the at least one channel ambience audio signal.

The at least one microphone audio signal from which is generated the at least one channel voice audio signal and metadata; and the at least one microphone audio signal from which is generated the at least one channel ambience audio signal and metadata may comprise: separate groups of microphones with no microphones in common; or groups of microphones with at least one microphone in common.

The method may further comprise receiving an input configured to control the generation of the encoded multichannel audio signal.

The method may further comprise modifying a position parameter of the metadata associated with the at least one channel voice audio signal or change a near-channel rendering-channel allocation associated with the at least one channel voice audio signal based on a determined mismatch between the position parameter of the metadata associated with the at least one channel voice audio signal and an allocated near-channel rendering-channel channel.

Generating an encoded multichannel audio signal based on the at least one channel voice audio signal and metadata and further the at least one channel ambience audio signal and metadata may comprise: obtaining an encoder bit rate; select embedded coding levels and allocate a bit rate to each of the selected embedded coding levels, wherein a first level is associated with the at least one channel voice audio signal and metadata, a second level is associated with the at least one channel ambience audio signal, and a third level is associated with the metadata associated with the at least one channel ambience audio signal; encoding at least one channel voice audio signal and metadata, the at least one channel ambience audio signal and metadata associated with the at least one channel ambience audio signal based on the allocated bit rates.

The method may further comprise determining a capability parameter, the capability parameter being determined based on at least one of: a transmission channel capacity; a rendering apparatus capacity, wherein generating an encoded multichannel audio signal may comprise generating an encoded multichannel audio signal further based on the capability parameter.

Generating an encoded multichannel audio signal further based on the capability parameter may comprise selecting embedded coding levels and allocating a bit rate to each of the selected embedded coding levels based on at least one of the at least one of the transmission channel capacity and the rendering apparatus capacity.

The at least one microphone audio signal used to generate the at least one channel ambience audio signal and metadata based on a parametric analysis may comprise at least two microphone audio signals.

The method may further comprise outputting the encoded multichannel audio signal.

According to a fourth aspect there is provided a method comprising: receiving an embedded encoded audio signal, the embedded encoded audio signal comprising at least one of the following levels of embedded audio signal: at least one channel voice audio signal and associated metadata to be rendered as a spatial voice scene; at least one channel voice audio signal and associated metadata, and at least one channel ambience audio signal to be rendered as a near-far stereo scene; at least one channel voice audio signal and associated metadata, and at least one channel ambience audio signal and associated spatial metadata to be rendered as a spatial audio scene; and decoding the embedded encoded audio signal and output a multichannel audio signal representing the scene and such that the multichannel audio signal enables the spatial presentation of the at least one channel voice audio signal independent of the at least one channel ambience channel audio signal.

The levels of embedded audio signal may further comprise at least one channel voice audio signal and associated metadata, and at least one channel ambience audio signal and associated spatial metadata to be rendered as a spatial audio scene and at least one further audio object audio signal and associated metadata and wherein decoding the embedded encoded audio signal and outputting a multichannel audio signal representing the scene may comprise decoding and outputting a multichannel audio signal, such that the spatial presentation of the at least one further audio object audio signal is spatially independent of the at least one channel voice audio signal and the at least one channel ambience audio signal.

The method may further comprise receiving an input configured to control the decoding of the embedded encoded audio signal and output of the multichannel audio signal.

The input may comprise a switch of capability wherein decoding the embedded encoded audio signal and outputting a multichannel audio signal may comprise updating the decoding and outputting based on the switch of capability.

The switch of capability may comprise at least one of: a determination of earbud/earphone configuration; a determination of headphone configuration; and a determination of speaker output configuration.

The input may comprise a determination of a change of embedded level wherein decoding the embedded encoded audio signal and outputting a multichannel audio signal may comprise updating the decoding and outputting based on the change of embedded level.

The input may comprise a determination of a change of bit rate for the embedded level wherein decoding the embedded encoded audio signal and outputting a multichannel audio signal may comprise updating the decoding and outputting based on the change of bit rate for the embedded level.

The method may comprise controlling the decoding of the embedded encoded audio signal and outputting of the multichannel audio signal to modify at least one channel voice audio signal position or change a near-channel rendering-channel allocation associated with the at least one channel voice audio signal based on a determined mismatch between at least one voice audio signal detected position and/or an allocated near-channel rendering-channel channel.

The input may comprise a determination of correlation between the at least one channel voice audio signal and the at least one channel ambience audio signal, and the decoding and the outputting a multichannel audio signal may comprise: when the correlation is less than a determined threshold then: controlling a position associated with the at least one channel voice audio signal, and controlling an ambient spatial scene formed by the at least one channel ambience audio signal by rotating the ambient spatial scene, based on the at least one channel ambience audio signal, according to an obtained rotation parameter or compensating for a rotation of the further device by applying a corresponding opposite rotation to the ambient spatial scene; and when the correlation is greater than or equal to the determined threshold then: controlling a position associated with the at least one channel voice audio signal, and controlling an ambient spatial scene formed by the at least one channel ambience audio signal by compensating for a rotation of the further device by applying a corresponding opposite rotation to the ambient spatial scene while letting the rest of the scene rotate or rotating the ambient spatial scene, based on the at least one channel ambience audio signal, according to an obtained rotation parameter.

According to a fifth aspect there is provided an apparatus comprising at least one processor and at least one memory including a computer program code, the at least one memory and the computer program code configured to, with the at least one processor, cause the apparatus at least to: receive at least one channel voice audio signal and metadata associated with the at least one channel voice audio signal, the at least one channel voice audio signal and metadata generated from at least one microphone audio signal; receive at least one channel ambience audio signal and metadata associated with the at least one channel ambience audio signal, wherein the at least one channel ambience audio signal and metadata are generated based on a parametric analysis of at least one microphone audio signal, and the at least one channel ambience audio signal is associated with the at least one channel voice audio signal; and generate an encoded multichannel audio signal based on the at least one channel voice audio signal and metadata and further the at least one channel ambience audio signal and metadata, such that the encoded multichannel audio signal enables the spatial presentation of the at least one channel voice audio signal spatially independent of the at least one channel ambience audio signal.

The apparatus may be further caused to receive at least one further audio object audio signal, wherein the apparatus caused to generate an encoded multichannel audio signal is caused to generate the encoded multichannel audio signal further based on the at least one further audio object audio signal such that the encoded multichannel audio signal enables the spatial presentation of the at least one further audio object audio signal spatially independent of the at least one channel voice audio signal and the at least one channel ambience audio signal.

The at least one microphone audio signal from which is generated the at least one channel voice audio signal and metadata; and the at least one microphone audio signal from which is generated the at least one channel ambience audio signal and metadata may comprise: separate groups of microphones with no microphones in common; or groups of microphones with at least one microphone in common.

The apparatus may be further caused to receive an input configured to control the generation of the encoded multichannel audio signal.

The apparatus may be further caused to modify a position parameter of the metadata associated with the at least one channel voice audio signal or change a near-channel rendering-channel allocation associated with the at least one channel voice audio signal based on a determined mismatch between the position parameter of the metadata associated with the at least one channel voice audio signal and an allocated near-channel rendering-channel channel.

The apparatus caused to generate an encoded multichannel audio signal based on the at least one channel voice audio signal and metadata and further the at least one channel ambience audio signal and metadata may be caused to: obtain an encoder bit rate; select embedded coding levels and allocate a bit rate to each of the selected embedded coding levels, wherein a first level is associated with the at least one channel voice audio signal and metadata, a second level is associated with the at least one channel ambience audio signal, and a third level is associated with the metadata associated with the at least one channel ambience audio signal; encode at least one channel voice audio signal and metadata, the at least one channel ambience audio signal and metadata associated with the at least one channel ambience audio signal based on the allocated bit rates.

The apparatus may be further caused to determine a capability parameter, the capability parameter being determined based on at least one of: a transmission channel capacity; a rendering apparatus capacity, wherein the apparatus caused to generate an encoded multichannel audio signal may be caused to generate an encoded multichannel audio signal further based on the capability parameter.

The apparatus caused to generate an encoded multichannel audio signal further based on the capability parameter may be caused to select embedded coding levels and allocate a bit rate to each of the selected embedded coding levels based on at least one of the at least one of the transmission channel capacity and the rendering apparatus capacity.

The at least one microphone audio signal used to generate the at least one channel ambience audio signal and metadata based on a parametric analysis may comprise at least two microphone audio signals.

The apparatus may be further caused to output the encoded multichannel audio signal.

According to a sixth aspect there is provided an apparatus comprising at least one processor and at least one memory including a computer program code, the at least one memory and the computer program code configured to, with the at least one processor, cause the apparatus at least to: receive an embedded encoded audio signal, the embedded encoded audio signal comprising at least one of the following levels of embedded audio signal: at least one channel voice audio signal and associated metadata to be rendered as a spatial voice scene; at least one channel voice audio signal and associated metadata , and at least one channel ambience audio signal to be rendered as a near-far stereo scene; at least one channel voice audio signal and associated metadata, and at least one channel ambience audio signal and associated spatial metadata to be rendered as a spatial audio scene; and decode the embedded encoded audio signal and output a multichannel audio signal representing the scene and such that the multichannel audio signal enables the spatial presentation of the at least one channel voice audio signal independent of the at least one channel ambience channel audio signal.

The levels of embedded audio signal may further comprise at least one channel voice audio signal and associated metadata, and at least one channel ambience audio signal and associated spatial metadata to be rendered as a spatial audio scene and at least one further audio object audio signal and associated metadata and wherein the apparatus caused to decode the embedded encoded audio signal and output a multichannel audio signal representing the scene may be caused to decode and output a multichannel audio signal, such that the spatial presentation of the at least one further audio object audio signal is spatially independent of the at least one channel voice audio signal and the at least one channel ambience audio signal.

The apparatus may be further caused to receive an input configured to control the decoding of the embedded encoded audio signal and output of the multichannel audio signal.

The input may comprise a switch of capability wherein the apparatus caused to decode the embedded encoded audio signal and output a multichannel audio signal may be caused to update the decoding and outputting based on the switch of capability.

The switch of capability may comprise at least one of: a determination of earbud/earphone configuration; a determination of headphone configuration; and a determination of speaker output configuration.

The input may comprise a determination of a change of embedded level wherein the apparatus caused to decode the embedded encoded audio signal and output a multichannel audio signal may be caused to update the decoding and outputting based on the change of embedded level.

The input may comprise a determination of a change of bit rate for the embedded level wherein the apparatus caused to decode the embedded encoded audio signal and output a multichannel audio signal may be caused to update the decoding and outputting based on the change of bit rate for the embedded level.

The apparatus may be caused to control the decoding of the embedded encoded audio signal and output of the multichannel audio signal to modify at least one channel voice audio signal position or change a near-channel rendering-channel allocation associated with the at least one channel voice audio signal based on a determined mismatch between at least one voice audio signal detected position and/or an allocated near-channel rendering-channel channel.

The input may comprise a determination of correlation between the at least one channel voice audio signal and the at least one channel ambience audio signal, and the apparatus caused to decode and output a multichannel audio signal may be caused to: when the correlation is less than a determined threshold then: control a position associated with the at least one channel voice audio signal, and control an ambient spatial scene formed by the at least one channel ambience audio signal by rotating the ambient spatial scene, based on the at least one channel ambience audio signal, according to an obtained rotation parameter or compensating for a rotation of the further device by applying a corresponding opposite rotation to the ambient spatial scene; and when the correlation is greater than or equal to the determined threshold then: control a position associated with the at least one channel voice audio signal, and control an ambient spatial scene formed by the at least one channel ambience audio signal by compensating for a rotation of the further device by applying a corresponding opposite rotation to the ambient spatial scene while letting the rest of the scene rotate or rotating the ambient spatial scene, based on the at least one channel ambience audio signal, according to an obtained rotation parameter.

According to a seventh aspect there is provided an apparatus comprising receiving circuitry configured to receive at least one channel voice audio signal and metadata associated with the at least one channel voice audio signal, the at least one channel voice audio signal and metadata generated from at least one microphone audio signal; receiving circuitry configured to receive at least one channel ambience audio signal and metadata associated with the at least one channel ambience audio signal, wherein the at least one channel ambience audio signal and metadata are generated based on a parametric analysis of at least one microphone audio signal, and the at least one channel ambience audio signal is associated with the at least one channel voice audio signal; and encoding circuitry configured to generate an encoded multichannel audio signal based on the at least one channel voice audio signal and metadata and further the at least one channel ambience audio signal and metadata, such that the encoded multichannel audio signal enables the spatial presentation of the at least one channel voice audio signal spatially independent of the at least one channel ambience audio signal.

According to an eighth aspect there is provided an apparatus comprising: receiving circuitry configured to receive an embedded encoded audio signal, the embedded encoded audio signal comprising at least one of the following levels of embedded audio signal: at least one channel voice audio signal and associated metadata to be rendered as a spatial voice scene; at least one channel voice audio signal and associated metadata , and at least one channel ambience audio signal to be rendered as a near-far stereo scene; at least one channel voice audio signal and associated metadata, and at least one channel ambience audio signal and associated spatial metadata to be rendered as a spatial audio scene; and decoding circuitry configured to decode the embedded encoded audio signal and output a multichannel audio signal representing the scene and such that the multichannel audio signal enables the spatial presentation of the at least one channel voice audio signal independent of the at least one channel ambience channel audio signal.

According to a ninth aspect there is provided a computer program comprising instructions [or a computer readable medium comprising program instructions] for causing an apparatus to perform at least the following: receiving at least one channel voice audio signal and metadata associated with the at least one channel voice audio signal, the at least one channel voice audio signal and metadata generated from at least one microphone audio signal; receiving at least one channel ambience audio signal and metadata associated with the at least one channel ambience audio signal, wherein the at least one channel ambience audio signal and metadata are generated based on a parametric analysis of at least one microphone audio signal, and the at least one channel ambience audio signal is associated with the at least one channel voice audio signal; and generating an encoded multichannel audio signal based on the at least one channel voice audio signal and metadata and further the at least one channel ambience audio signal and metadata, such that the encoded multichannel audio signal enables the spatial presentation of the at least one channel voice audio signal spatially independent of the at least one channel ambience audio signal.

According to a tenth aspect there is provided a computer program comprising instructions [or a computer readable medium comprising program instructions] for causing an apparatus to perform at least the following: receiving an embedded encoded audio signal, the embedded encoded audio signal comprising at least one of the following levels of embedded audio signal: at least one channel voice audio signal and associated metadata to be rendered as a spatial voice scene; at least one channel voice audio signal and associated metadata, and at least one channel ambience audio signal to be rendered as a near-far stereo scene; at least one channel voice audio signal and associated metadata, and at least one channel ambience audio signal and associated spatial metadata to be rendered as a spatial audio scene; and decoding the embedded encoded audio signal and output a multichannel audio signal representing the scene and such that the multichannel audio signal enables the spatial presentation of the at least one channel voice audio signal independent of the at least one channel ambience channel audio signal.

According to an eleventh aspect there is provided a non-transitory computer readable medium comprising program instructions for causing an apparatus to perform at least the following: receiving at least one channel voice audio signal and metadata associated with the at least one channel voice audio signal, the at least one channel voice audio signal and metadata generated from at least one microphone audio signal; receiving at least one channel ambience audio signal and metadata associated with the at least one channel ambience audio signal, wherein the at least one channel ambience audio signal and metadata are generated based on a parametric analysis of at least one microphone audio signal, and the at least one channel ambience audio signal is associated with the at least one channel voice audio signal; and generating an encoded multichannel audio signal based on the at least one channel voice audio signal and metadata and further the at least one channel ambience audio signal and metadata, such that the encoded multichannel audio signal enables the spatial presentation of the at least one channel voice audio signal spatially independent of the at least one channel ambience audio signal.

According to a twelfth aspect there is provided a non-transitory computer readable medium comprising program instructions for causing an apparatus to perform at least the following: receiving an embedded encoded audio signal, the embedded encoded audio signal comprising at least one of the following levels of embedded audio signal: at least one channel voice audio signal and associated metadata to be rendered as a spatial voice scene; at least one channel voice audio signal and associated metadata, and at least one channel ambience audio signal to be rendered as a near-far stereo scene; at least one channel voice audio signal and associated metadata, and at least one channel ambience audio signal and associated spatial metadata to be rendered as a spatial audio scene; and decoding the embedded encoded audio signal and output a multichannel audio signal representing the scene and such that the multichannel audio signal enables the spatial presentation of the at least one channel voice audio signal independent of the at least one channel ambience channel audio signal.

According to a thirteenth aspect there is provided an apparatus comprising: means for receiving at least one channel voice audio signal and metadata associated with the at least one channel voice audio signal, the at least one channel voice audio signal and metadata generated from at least one microphone audio signal; means for receiving at least one channel ambience audio signal and metadata associated with the at least one channel ambience audio signal, wherein the at least one channel ambience audio signal and metadata are generated based on a parametric analysis of at least one microphone audio signal, and the at least one channel ambience audio signal is associated with the at least one channel voice audio signal; and means for generating an encoded multichannel audio signal based on the at least one channel voice audio signal and metadata and further the at least one channel ambience audio signal and metadata, such that the encoded multichannel audio signal enables the spatial presentation of the at least one channel voice audio signal spatially independent of the at least one channel ambience audio signal.

According to a fourteenth aspect there is provided an apparatus comprising: means for receiving an embedded encoded audio signal, the embedded encoded audio signal comprising at least one of the following levels of embedded audio signal: at least one channel voice audio signal and associated metadata to be rendered as a spatial voice scene; at least one channel voice audio signal and associated metadata, and at least one channel ambience audio signal to be rendered as a near-far stereo scene; at least one channel voice audio signal and associated metadata, and at least one channel ambience audio signal and associated spatial metadata to be rendered as a spatial audio scene; and means for decoding the embedded encoded audio signal and output a multichannel audio signal representing the scene and such that the multichannel audio signal enables the spatial presentation of the at least one channel voice audio signal independent of the at least one channel ambience channel audio signal.

According to a fifteenth aspect there is provided a computer readable medium comprising program instructions for causing an apparatus to perform at least the following: receiving at least one channel voice audio signal and metadata associated with the at least one channel voice audio signal, the at least one channel voice audio signal and metadata generated from at least one microphone audio signal; receiving at least one channel ambience audio signal and metadata associated with the at least one channel ambience audio signal, wherein the at least one channel ambience audio signal and metadata are generated based on a parametric analysis of at least one microphone audio signal, and the at least one channel ambience audio signal is associated with the at least one channel voice audio signal; and generating an encoded multichannel audio signal based on the at least one channel voice audio signal and metadata and further the at least one channel ambience audio signal and metadata, such that the encoded multichannel audio signal enables the spatial presentation of the at least one channel voice audio signal spatially independent of the at least one channel ambience audio signal.

According to a sixteenth aspect there is provided a computer readable medium comprising program instructions for causing an apparatus to perform at least the following: receiving an embedded encoded audio signal, the embedded encoded audio signal comprising at least one of the following levels of embedded audio signal: at least one channel voice audio signal and associated metadata to be rendered as a spatial voice scene; at least one channel voice audio signal and associated metadata, and at least one channel ambience audio signal to be rendered as a near-far stereo scene; at least one channel voice audio signal and associated metadata, and at least one channel ambience audio signal and associated spatial metadata to be rendered as a spatial audio scene; and decoding the embedded encoded audio signal and output a multichannel audio signal representing the scene and such that the multichannel audio signal enables the spatial presentation of the at least one channel voice audio signal independent of the at least one channel ambience channel audio signal.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIGS. 1 and 2 show schematically a typical audio capture scenario which may be experienced when employing a mobile device;

FIG. 3a shows schematically an example encoder and decoder architecture;

FIGS. 3b and 3c show schematically example input devices suitable for employing in some embodiments;

FIG. 4 shows schematically example decoder/renderer apparatus suitable for receiving the output of FIG. 3c;

FIG. 5 shows schematically an example encoder and decoder architecture according to some embodiments;

FIG. 6 shows schematically an example input format according to some embodiments;

FIG. 7 shows schematically an example embedded scheme with three layers according to some embodiments;

FIGS. 8a and 8b schematically shows example input generators, codec generators, encoder, decoder and output device architectures suitable for implementing some embodiments;

FIG. 9 shows a flow diagram of the embedded format encoding according to some embodiments;

FIG. 10 shows a flow diagram of embedded format encoding and the level selection and the waveform and metadata encoding in further detail according to some embodiments;

FIGS. 11a to 11d show example rendering/presentation apparatus according to some embodiments;

FIG. 12 shows an example immersive rendering of a voice object and MASA ambience audio for a stereo headphone output according to some embodiments;

FIG. 13 shows an example change in rendering under bit switching (where the embedded level drops) implementing an example near-far representation according to some embodiments;

FIG. 14 shows an example switching between mono and stereo capability;

FIG. 15 shows a flow diagram of a rendering control method including presentation-capability switching according to some embodiments;

FIG. 16 shows an example of rendering control during a change from an immersive mode to an embedded format mode for a stereo output according to some embodiments;

FIG. 17 shows an example of rendering control during a change from an embedded format mode caused by a capability change according to some embodiments;

FIG. 18 shows an example of rendering control during a change from an embedded format mode caused by a capability change from mono to stereo according to some embodiments;

FIG. 19 shows an example of rendering control during an embedded format mode change from mono to immersive mode according to some embodiments;

FIG. 20 shows an example of rendering control during adaptation of the lower spatial dimension audio based on user interaction in higher spatial dimension audio according to some embodiments;

FIG. 21 shows examples of user experience allowed by methods as employed in some embodiments;

FIG. 22 shows examples of near-far stereo channel preference selection when answering a call when implementing some embodiments; and

FIG. 23 shows an example device suitable for implementing the apparatus shown.

### EMBODIMENTS OF THE APPLICATION

The following describes in further detail suitable apparatus and possible mechanisms for spatial voice and audio ambience input format definitions and encoding frameworks for IVAS. In such embodiments there can be provided a backwards-compatible delivery and playback for stereo and mono representations with embedded structure and capability for corresponding presentation. The presentation-capability switching enables in some embodiments a decoder/renderer to allocate voice in optimal channel without need for blind downmixing in presentation device, e.g., in a way that does not correspond to transmitter preference. The input format definition and the encoding framework may furthermore be particularly well suited for practical mobile device spatial audio capture (e.g., better allowing for UE-on-ear immersive capture).

The concept which is described with respect to the embodiments below are configured to define an input format and metadata signaling with separate voice and spatial audio. In such embodiments the full audio scene is provided to a suitable encoder in (at least) two captured streams. A first stream is a mono voice object based on at least one microphone capture and a second stream is parametric spatial ambience signals based on a parametric analysis of signals from at least three microphones. In some embodiments optionally, audio objects of additional sound sources may be provided. The metadata signaling may comprise at least a voice priority indicator for the voice object stream (and optionally its spatial position). The first stream can at least predominantly relate to user voice and audio content near to user's mouth (near channel), whereas the second stream can at least predominantly relate to audio content farther from user's mouth (far channel).

In some embodiments the input format is generated in order to facilitate orientation compensation of correlated and/or uncorrelated signals. For example for uncorrelated first and second signals, the signals may be treated independently and for correlated first and second signals parametric spatial audio (MASA) metadata can be modified according to a voice object position.

In some embodiments a spatial voice and audio encoding can be provided according to the defined input format. The encoding may be configured to allow a separation of voice and spatial ambience, where prior to waveform and metadata encoding, voice object positions are modified (if needed) or where updates to near-channel rendering-channel allocation are applied based on mismatches between active portions of the voice object real position and the allocated channel.

In some embodiments there is provided rendering control and presentation based on changing level of immersion (of the transmitted signal) and presentation device capability. For example in some embodiments audio signal rendering properties are modified according to switched capability communicated to the decoder/renderer. In some embodiments the audio signal rendering properties and channel allocation may be modified according to change in embedded level received over transmission. Also in some embodiments the audio signals may be rendered according to rendering properties and channel allocation to one or more output channels. In other words the near and far signals (which is a 2-channel or stereo representation different from traditional stereo representation using left and right stereo channels) are allocated to a left and right channel stereo presentation according to some pre-determined information. Similarly, the near and far signals can have channel allocation or downmix information indicating how a mono presentation should be carried out.

Furthermore in some embodiments according to a UE setting (e.g., selected by user via UI or provided by the immersive voice service) and/or spatial analysis a spatial position for a mono voice signal (near signal) can be used in a spatial IVAS audio stream. The MASA signal (spatial ambience, far signal) in such embodiments is configured to automatically contain spatial information obtained during the MASA spatial analysis.

Thus, in some embodiments, the audio signals can be decoded and rendered according to transmission bit rate and rendering capability to provide to the receiving user or listener one of:
1. Mono. Voice object.
2. Stereo. Voice (as a mono channel)+ambience (as a further mono channel) according to near-far two-channel configuration.
3. Full spatial audio. Correct spatial placement for the transmitted streams is provided, where mono voice object is rendered at the object position and the spatial ambience consists of both directional components and diffuse sound field.

In some embodiments it may be possible to utilize EVS encoding of mono voice/audio waveforms for additional backwards interoperability of the transmitted stream(s).

Mobile handsets or devices, here also referred to as UEs (user equipment), represent the largest market segment for immersive audio services with sales above the 1 billion mark annually. In terms of spatial playback, the devices can be connected to stereo headphones (preferably with head-tracking). In terms of spatial capture, a UE itself can be considered a preferred device. In order to grow the popularity of multi-microphone spatial audio capture in the market and to allow the immersive audio experience for as many users as possible, optimizing the capture and codec performance for immersive communications is therefore an aspect which has been considered in some detail.

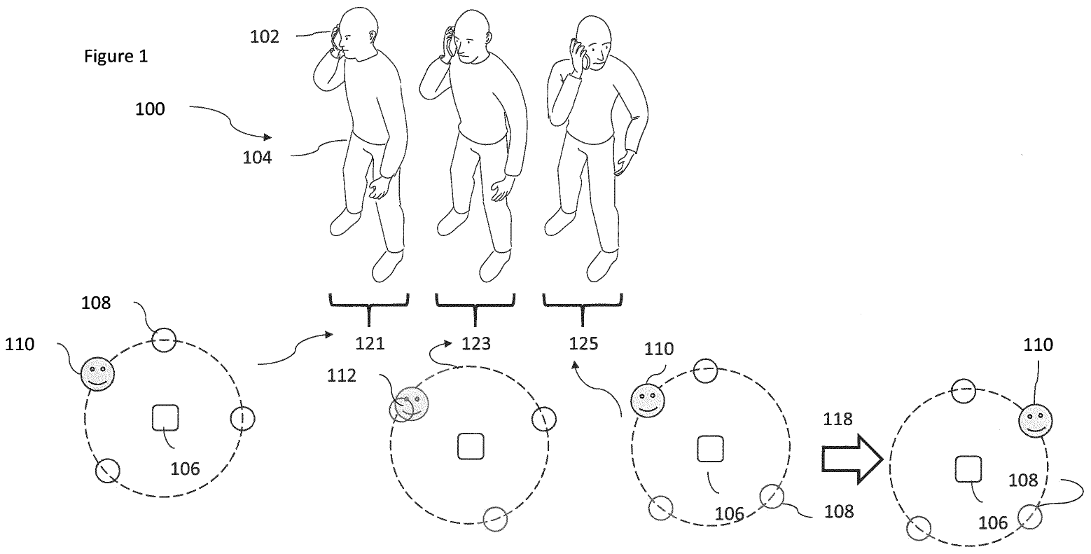

FIG. 1 for example shows a typical audio capture scenario 100 on a mobile device. In this example there is a first user 104 who does not have headphones with them. Thus, the user 104 makes a call with UE 102 on their ear. The user may call a further user 106 who is equipped with stereo headphones and therefore is able to hear spatial audio captured by the first user using the headphones. Based on the first user's spatial audio capture, an immersive experience for the second user can be provided. Considering, e.g., regular MASA capture and encoding, it can however be problematic that the device is on the capturing user's ear. For example, the user voice may dominate the spatial capture reducing the level of immersion. Also, all the head rotations by the user as well as device rotations relative to the user's head result in audio scene rotations for the receiving user. This may provide user confusion in some cases. Thus for example at time 121 the spatial audio scene captured is a first orientation as shown by the rendered sound scene from the experience of the further user 106 which shows the first user 110 at a first position relative to the further user 106 and one audio source 108 (of the more than one audio source in the scene) at a position directly in front of the further user 106. Then as the user turns their head at time 123 and turns further at time 125 then the captured spatial scene rotates which is shown by the rotation of the audio source 108 relative to the position of the further user 106 and the audio position of the first user 110. This for example could cause an overlapping 112 of the audio sources. Furthermore if the rotation is compensated, shown by arrow 118 with respect to the time 125, using the user device's sensor information, then the position of the audio source of the first user (the first user's voice) rotates the other way, making the experience worse.

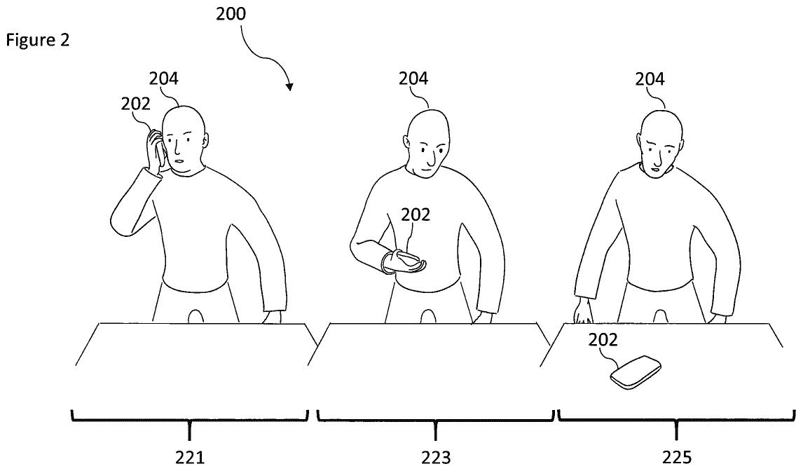

FIG. 2 shows a further audio capture scenario 200 using a mobile device. The user 204 may, e.g., begin (as seen on the left 221) with the UE 202 operating in UE-on-ear capture mode and then change to a hands-free mode (which may be, e.g., handheld hands-free as shown at the centre 223 of FIG. 2 or UE/device 202 placed on table as shown on the right 225 of FIG. 2). The further user/listener may also wear earbuds or headphones for the presentation of the captured audio signals. In this case, the listener/further user may walk around in handheld hands-free mode or, e.g., move around the device placed on table (in hands-free capture mode). In this example use case the device rotations relative to the user voice position and the overall immersive audio scene are significantly more complex than in the case of FIG. 1, although this is similarly a fairly simple and typical use case for practical conversational applications.

In some embodiments the various device rotations can be at least partly compensated in the capture side spatial analysis based on any suitable sensor such as a gyroscope, magnetometer, accelerometer, and/or orientation sensors. Alternatively, the capture device rotations can in some embodiments be compensated on the playback-side, if the rotation compensation angle information is sent as side-information (or metadata). The embodiments as described herein show apparatus and methods enabling compensation of capture device rotations such that the compensation or audio modification can be applied separately to the voice and the background sound spatial audio (in other words, e.g., only the ‘near’ or the ‘far’ audio signals can be compensated).

One key use case for IVAS is an automatic stabilization of audio scene (particularly for practical audio-only mobile capture) where an audio call is established between two participants, a participant with immersive audio capture capability, e.g., begins the call with their UE on their ear, but switches to hand-held hands-free and ultimately to hands-free with device on table, and a spatial sound scene is transmitted and rendered to the other party in a manner which does not cause the listener to experience either incorrect rotation of the ‘near’ audio signals or the ‘far’ audio signals.

An example of this would be where a user, Bob, is heading home from work. He walks across a park and suddenly recalls he still needs to discuss the plans for the weekend. He places an immersive audio call to a further user, his friend Peter, to transmit also the nice ambience with birds singing in the trees around him. Bob does not have headphones with him, so he holds the smartphone to his ear to hear Peter better. On his way home he stops at the intersection and looks left and right and once more left to safely cross the street. As soon as Bob gets home, he switches to hand-held hands-free operation and finally places the smartphone on the table to continue the call over the loudspeaker. The spatial capture provides also the directional sounds of Bob's cuckoo clock collection to Peter. A stable immersive audio scene is provided to Peter regardless of the capture device orientation and operation mode changes.

The embodiments thus attempt to optimise capture for practical mobile device use cases such that the voice dominance of the spatial audio representation is minimized and both the directional voice as well spatial background remain stable during capture device rotation.

Additionally the embodiments attempt to enable backwards interoperability with the 3GPP EVS which IVAS is an extension of and to provide mono-compatibility with EVS. Additionally the embodiments allow also for stereo and spatial compatibility. This is specifically in spatial audio for the UE-on-ear use case (as shown, e.g., in FIG. 1).

Furthermore the embodiments attempt to provide an optimal audio rendering to a listener based on various rendering capabilities available to the user on their device. Specifically some embodiments attempt to realise a low-complexity switching/downmix to a lower spatial dimension from a spatial audio call. In some embodiments this can be implemented within an immersive audio voice call from a UE with various rendering or presentation methods.

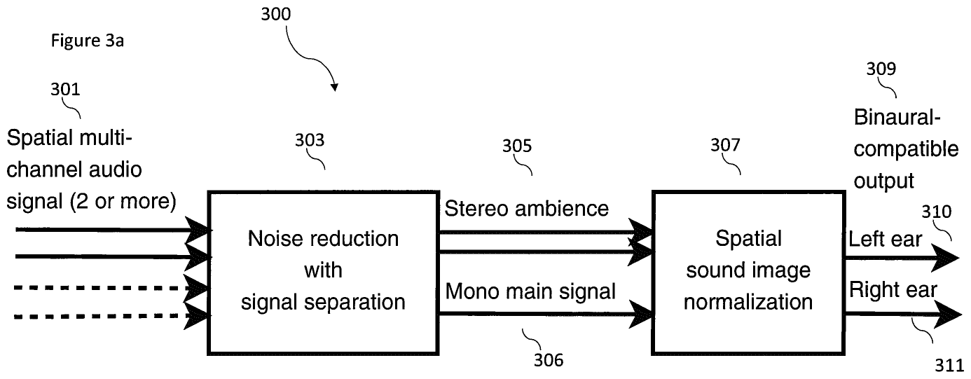

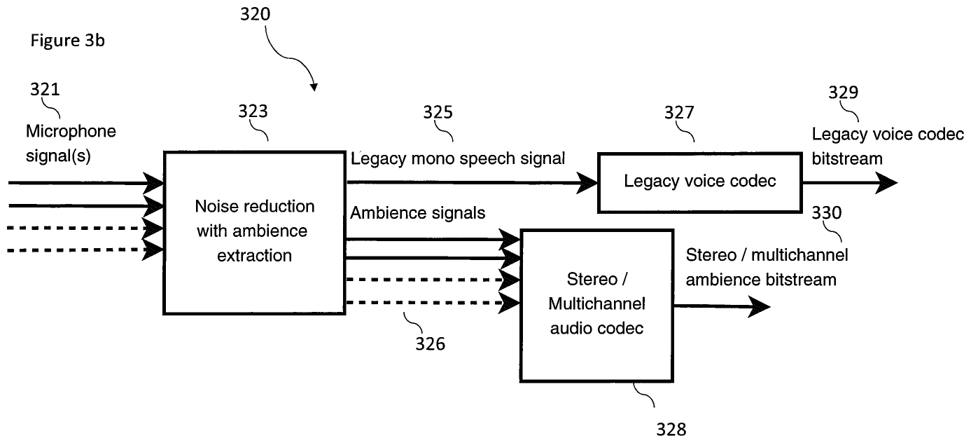

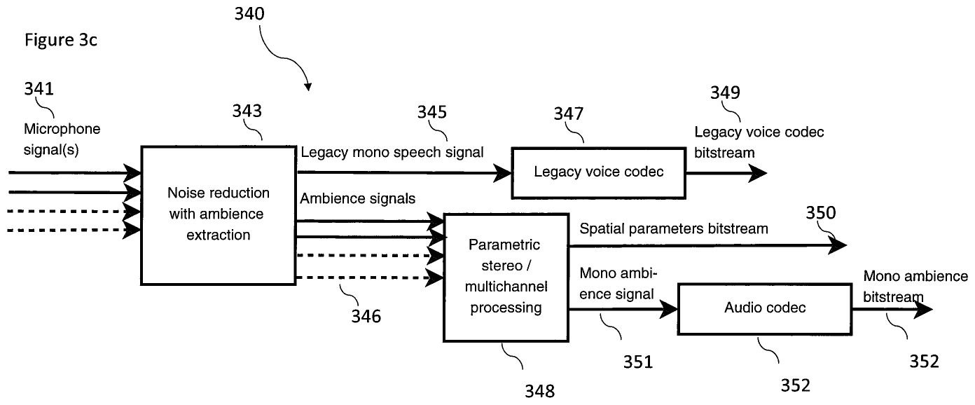

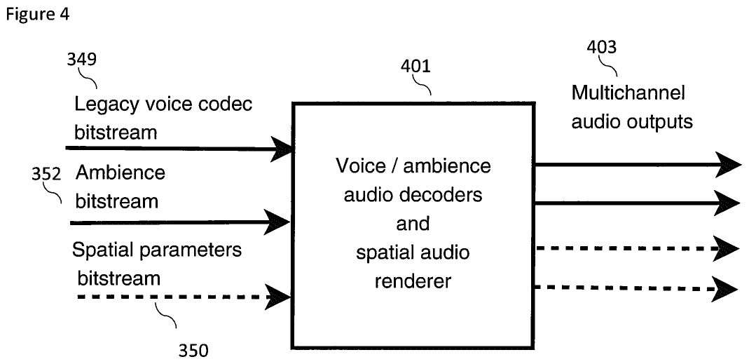

FIGS. 3a to 3c and 4 show example capture and presentation apparatus which provides a suitable relevant background from which the embodiments can be described.

For example, FIG. 3a shows a multi-channel capture and binaural audio presentation apparatus 300. In this example the spatial multichannel audio signals (2 or more channels) 301 is provided to a noise reduction with signal separation processor 303 which is configured to perform noise reduction and signal separation. For example this may be carried out by generating a noise reduced main mono signal 306 (containing mostly near-field speech), extracted from the original mono-/ stereo-/ multimicrophone signal. This uses normal mono or multimicrophone noise suppressor technology used by many current devices. This stream is sent as is to the receiver as a backwards compatible stream. Additionally the noise reduction with signal separation processor 303 is configured to generate ambience signal(s) 305. These can be obtained by removing the mono signal (speech) from all microphone signals, thus resulting as many ambience streams as there are microphones. Depending on the method there are thus one or more spatial signals available for further coding.

The mono 306 and ambience 305 audio signals may then be processed by a spatial sound image normalization processor 307 which implements a suitable spatial sound image processing in order to produce a binaural-compatible output 309 comprising a left ear 310 and right ear 311 output.

FIG. 3b shows an example first input generator (and encoder) 320. The input generator 320 is configured to receive the spatial microphone 321 (multichannel) audio signals which are provided to a noise reduction with ambience extraction processor 323 which is configured to perform mono speech signal 325 (containing mostly near-field speech) extraction from the multimicrophone signal and pass this to a legacy voice codec 327. Additionally ambiance signals 326 are generated (based on the microphone audio signals with the voice signals extracted) which can be passed to a suitable stereo/multichannel audio codec 328.

The legacy voice codec 327 encodes the mono speech audio signal 325 and outputs a suitable voice codec bitstream 329 and the stereo/multichannel audio codec 328 encodes the ambience audio signals 326 to output a suitable stereo/multichannel ambience bitstream 330.

FIG. 3c shows a second example input generator (and encoder) 340. The second input generator (and encoder) 340 is configured to receive the spatial microphone 341 (multichannel) audio signals which are provided to a noise reduction with ambience extraction processor 343 which is configured to perform mono speech signal 345 (containing mostly near-field speech) extraction from the multimicrophone signal and pass this to a legacy voice codec 347. Additionally ambiance signals 346 are generated (based on the microphone audio signals with the voice signals extracted) which can be passed to a suitable parametric stereo/multichannel audio processor 348.

The legacy voice codec 347 encodes the mono speech audio signal 345 and outputs a suitable voice codec bitstream 349.

The parametric stereo/multichannel audio processor 348 is configured to generate a mono ambience audio signal 351 which can be passed to a suitable audio codec 352 and spatial parameters bitstream 350. The audio codec 352 receives the mono ambience audio signal 251 and encodes it to generate a mono ambience bitstream 353.

FIG. 4 shows an example decoder/renderer 400 configured to process the bitstreams from FIG. 3c. Thus the decoder/renderer 400 comprises a voice/ambience audio decoder and spatial audio renderer 401 configured to receive the mono ambience bitstream 353, spatial parameters bitstream 350 and voice codec bitstream 349 and generate suitable multichannel audio outputs 403.

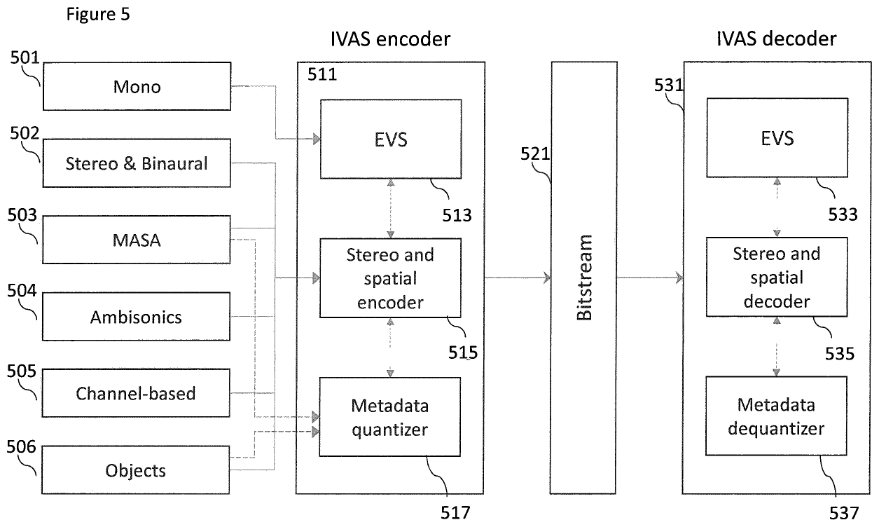

FIG. 5 shows a high-level overview of IVAS coder/decoder architecture suitable for implementing the embodiments as discussed hereafter. The system may comprise a series of possible input types including a mono audio signal input type 501, a stereo and binaural audio signal input type 502, a MASA input type 503, an Ambisonics input type 504, a channel-based audio signal input type 505, and audio objects input type 506.

The system furthermore comprises an IVAS encoder 511. The IVAS encoder 511 may comprise an enhanced voice service (EVS) encoder 513 which may be configured to receive a mono input format 501 and provide at least part of the bitstream 521 at least for some input types.

The IVAS encoder 511 may furthermore comprise a stereo and spatial encoder 515. The stereo and spatial encoder 515 may be configured to receive signals from any input from the stereo and binaural audio signal input type 502, the MASA input type 503, the Ambisonics input type 504, the channel-based audio signal input type 505, and the audio objects input type 506 and provide at least part of the bitstream 521. The EVS encoder 513 may in some embodiments be used to encode a mono audio signal derived from the input types 502, 503, 504, 505, 506.

Additionally the IVAS encoder 511 may comprise a metadata quantizer 517 configured to receive side information/metadata associated with the input types such as the MASA input type 503, the Ambisonics input type 504, the channel based audio signal input type 505, and the audio objects input type 506 and quantize/encode them to provide at least part of the bitstream 521.

The system furthermore comprises an IVAS decoder 531. The IVAS decoder 531 may comprise an enhanced voice service (EVS) decoder 533 which may be configured to receive the bitstream 521 and generate a suitable decoded mono signal for output or further processing.

The IVAS decoder 531 may furthermore comprise a stereo and spatial decoder 535. The stereo and spatial decoder 535 may be configured to receive the bitstream and decode them to generate suitable output signals.

Additionally the IVAS decoder 531 may comprise a metadata dequantizer 537 configured to receive the bitstream 521 and regenerate the metadata which may be used to assist in the spatial audio signal processing. For example, at least some spatial audio may be generated in the decoder based on a combination of the stereo and spatial decoder 535 and metadata dequantizer 537.

In the following examples the main input types of interest are MASA 503 and objects 506. The embodiments as described hereafter feature a codec input which may be a MASA+at least one object input, where the object is specifically used to provide the user voice. In some embodiments the MASA input may be correlated or uncorrelated with the user voice object. In some embodiments, a signalling related to this correlation status may be provided as an IVAS input (e.g., an input metadata).

In some embodiments the MASA 503 input is provided to the IVAS encoder as a mono or stereo audio signal and metadata. However in some embodiments the input can instead consists of 3 (e.g., planar first order Ambisonic−FOA) or 4 (e.g., FOA) channels. In some embodiments the encoder is configured to encode an Ambisonics input as MASA (e.g., via a modified DirAC encoding), channel-based input (e.g., 5.1 or 7.1+4) as MASA, or one or more object tracks as MASA or as a modified MASA representation. In some embodiments an object-based audio can be defined as at least a mono audio signal with associated metadata.

The embodiments as described herein may be flexible in terms of exact audio object input definition for the user voice object. In some embodiments a specific metadata flag defines the user voice object as the main signal (voice) for communications. For some input signal and codec configurations, like user-generated content (UGC), such signalling could be ignored or treated differently from the main conversational mode.

In some embodiments the UE is configured to implement spatial audio capture which provides not only a spatial signal (e.g., MASA) but a two-component signal, where user voice is treated separately. In some embodiments the user voice is represented by a mono object.

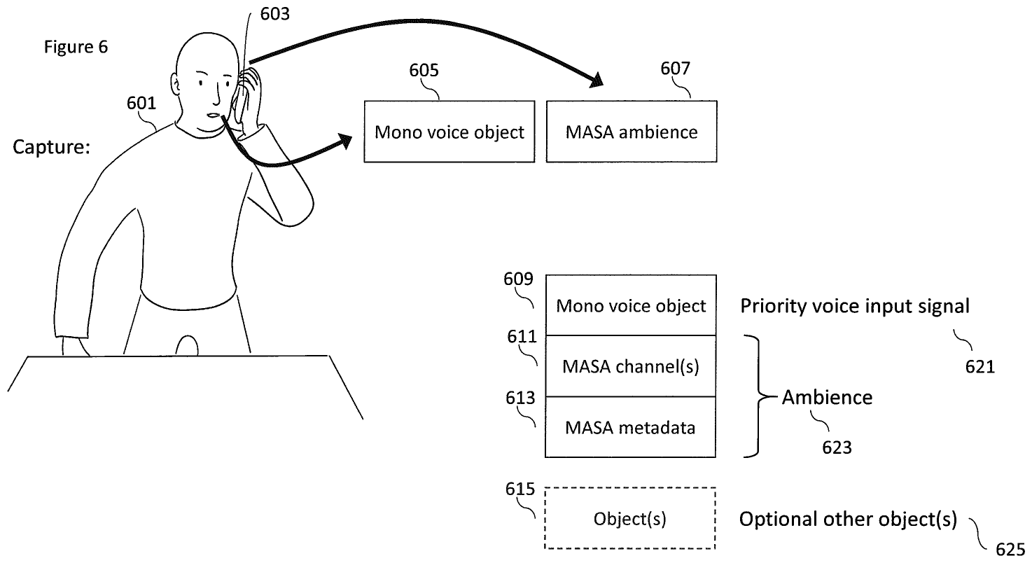

As such in some embodiments the UE is configured to provide at the IVAS encoder 511 input a combination such as ‘MASA+object(s)’. This for example is shown in FIG. 6 wherein the user 601 and the UE 603 are configured to capture/provide to a suitable IVAS encoder a mono voice object 605 and a MASA ambience 607 input. In other words the UE spatial audio capture provides not only a spatial signal (e.g., MASA) but rather a two-component signal, where user voice is treated separately.

Thus in some embodiments the input is a mono voice object 609 captured mainly using at least one microphone close to user's mouth. This at least one microphone may be a microphone on the UE or, e.g., a headset boom microphone or a so-called lavalier microphone from which the audio stream is provided to the UE.

In some embodiments the mono voice object has an associated voice priority signalling flag/metadata 621. The mono voice object 609 may comprise a mono waveform and metadata that includes at least the spatial position of the sound source (i.e., user voice). This position can be a real position, e.g., relative to the capture device (UE) position, or a virtual position based on some other setting/input. In practice, the voice object may otherwise utilize same/similar metadata than is generally known for object-based audio in the industry.

The following table summarizes minimum properties of the voice object according to some embodiments.

| Property | Description (value) |
|---|---|
| Audio waveform | Single mono waveform |
| | (intended for usern voice) |
| Metadata: voice priority | Indicates user voice signal |
| | with high(est) priority |
| Metadata: position | Object position (e.g., x-y-z or |
| | azimuth/elevation/(distance)) |

The following table provides some signalling options that can be utilized in addition or alternatively to regular object-audio position for the voice object according to some embodiments

| Property | Description (value) |
|---|---|
| Metadata: | Object position preference in two-channel |
| rendering | rendering (e.g., L/R, L/R/no-preference, |
| channel | L/R/both, L/R/both/no-preference). |
| | Property is intended for following intended |
| | rendering of the near-far stereo |
| | transmission. If binauralization is applied, |
| | it may be used ‘metadata: position’ instead. |
| Metadata: | Object position preference in two-channel |
| rendering | rendering indicated as balance value (i.e., |
| balance | a preferred balance between L and R). |
| | Property is intended for following intended |
| | rendering of the near-far stereo |
| | transmission. If binauralization is applied, |
| | it may be used ‘metadata: position’ instead. |
| Metadata: | Time/duration in rendering to move the |
| panning | content from the transmitted “L” channel to |
| coefficient | rendered “R” channel and vice versa. After |
| | panning (L-to-R/R-to-L switching) is |
| | performed, the current state can be |
| | maintained until next panning coefficient |
| | update or switch to a lower/higher spatial |
| | dimension. |
| Metadata: | Default gain for converting signaled voice |
| distance | object position (metadata field ‘position’) |
| gain | into a non-distance-based rendering, i.e., |
| | regular stereo or mono rendering. |
| | Property is intended for following intended |
| | rendering of voice object loudness in case |
| | of transmission or playback of non-immersive |
| | stream. |

In some embodiments, there can be implemented different signalling (metadata) for a voice object rendering channel where there is mono-only or near-far stereo transmission.

For an audio object, the object placement in a scene can be free. When a scene (consisting of at least the at least one object) is binauralized for rendering, an object position can, e.g., change over time. Thus, it can be provided also in voice-object metadata a time-varying position information (as shown in the above table).

The mono voice object input may be considered a ‘near’ signal that can be always rendered according to its signalled position in immersive rendering or alternatively downmixed to a fixed position in a reduced-domain rendering. By ‘near’, it is denoted the signal capture spatial position/distance relative to captured voice source. According to the embodiments, this ‘near’ signal is always provided to the user and always made audible in the rendering regardless of the exact presentation configuration and bit rate. For this purpose it is provided a voice priority metadata or equivalent signalling (as shown in the above table). This stream can in some embodiments be a default mono signal from an immersive IVAS UE, even in absence of any MASA spatial input.

Thus the spatial audio for immersive communications from immersive UE (smartphone) is represented as two parts. The first part may be defined as the voice signal in the form of the mono voice object 609.

The second part (the ambience part 623) may be defined as the spatial MASA signal (comprising the MASA channel(s) 611 and the MASA metadata 613). In some embodiments the spatial MASA signal, includes at least substantially no trace of or is only weakly correlated with the user voice object. For example, the mono voice object may be captured using a lavalier microphone or with strong beamforming.

In some embodiments it can be signalled for the voice object and the ambience signal an additional acoustic correlation (or separation) information. This metadata provides information on how much acoustic “leakage” or crosstalk there is between the voice object and the ambience signal. In particular, this information can be used to control the orientation compensation processing as explained hereafter.

In some embodiments, a processing of the spatial MASA signal is implemented. This may be according to following steps:
1. If there is no/low correlation between voice object and MASA ambient waveforms (Correlation<Threshold), then
   a. Control position of voice object independently
   b. Control MASA spatial scene by
      i. Letting MASA spatial scene rotate according to real rotations, OR
      ii. Compensating for device rotations by applying corresponding negative rotation to MASA spatial scene directions on a TF-tile-per-TF-tile basis
2. If there is correlation between voice object and MASA ambient waveforms (Correlation>=Threshold), then
   a. Control position of voice object
   b. Control MASA spatial scene by
      i. Compensating for device rotations of TF tiles corresponding to user voice (TF tile and direction) by applying rotation used in ‘a.’ to MASA spatial scene on a TF-tile-per-TF-tile basis (at least while VAD=1 for the voice object), while letting the rest of the scene rotate according to real capture device rotations, OR
      ii. Letting MASA spatial scene rotate according to real rotations, while making at least the TF tiles corresponding to user voice (TF tile and direction) diffuse (at least while VAD=1 for the voice object), where the amount of directional-to-diffuse modification can depend on a confidence value relating to MASA TF tile corresponding to user voice

It is understood above that the correlation calculation can be performed based on a long-term average (i.e., the decision is not carried out based on a correlation value calculated for a single frame) and may employ voice activity detection (VAD) to identify the presence of the user's voice within the voice object channel/signal. In some embodiments, the correlation calculation is based on an encoder processing of the at least two signals. In some embodiments, it is provided a metadata signalling, which can be at least partly based on capture-device specific information, e.g., in addition to signal correlation calculations.

In some embodiments the voice object position control may relate to a (pre-) determined voice position or a stabilization of the voice object in spatial scene. In other words, relating to the unwanted rotation compensation.

The confidence value consideration as discussed above can in some embodiments be a weighted function of angular distance (between the directions) and signal correlation.

It is here observed that the rotation compensation (for example in UE-on-ear spatial audio capture use cases) whether done locally in capture or in rendering if suitable signalling is implemented may be simplified when the voice is separated from the spatial ambience. The representation as discussed herein may also enable freedom of placement of the mono object (which need not be dependent of the scene rotation). Thus in some embodiments, the ambience can be delivered using a single audio waveform and the MASA metadata, where the device rotations may have been compensated in a way that there is no perceivable or annoying mismatch between the voice and the ambience (even if they correlate).

The MASA input audio can be, e.g., mono-based and stereo-based audio signals. There can thus be a mono waveform or a stereo waveform in addition to the MASA spatial metadata. In some embodiments, either type of input and transport can be implemented. However, a mono-based MASA input for the ambience in conjunction with the user voice object may in some embodiments be a preferred format.

In some embodiments there may also be optionally other objects 625 which are represented as objects 615 audio signals. These objects typically relate to some other audio components for the overall scene than the user voice. For example, user could add a virtual loudspeaker in the transmitted scene to play back a music signal. Such audio element would generally be provided to the encoder as an audio object.

As user voice is the main communications signal, for conversational operation a significant portion of the available bit rate may be allocated to the voice object encoding. For example, at 48 kbps it could be considered that about 20 kbps may be allocated to encode the voice with the remaining 28 kbps allocated to the spatial ambience representation. At such bit rates, and especially at lower bit rates, it can be beneficial to encode a mono representation of the spatial MASA waveforms to achieve the highest possible quality. For such reasons a mono-based MASA input may be the most practical in some examples.

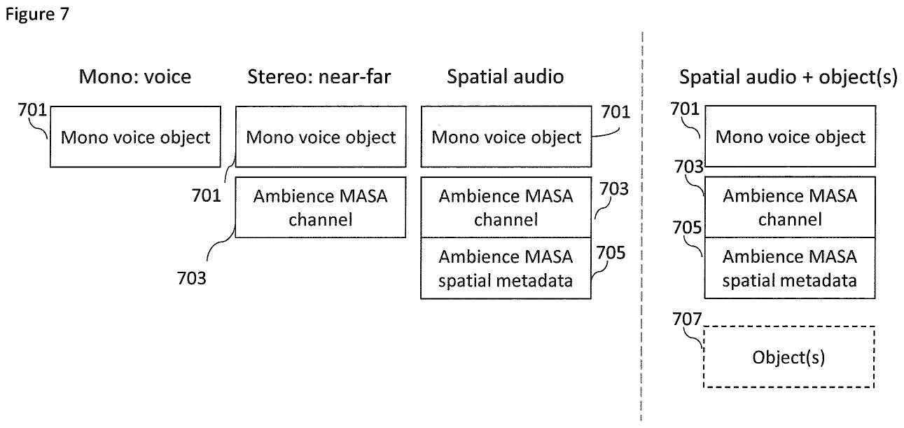

Another consideration is the embedded coding. A suitable embedded encoding scheme proposal, where a mono-based MASA (encoding) is practical, is provided in FIG. 7. The embedded encoded embodiments may enable three levels of embedded encoding.

The lowest level as shown by the Mono: voice column is a mono operation, which comprises the mono voice object 701. This can also be designated a ‘near’ signal.

The second level as shown by the Stereo: near-far column in FIG. 7 is a specific type of stereo operation. In such embodiments the input is both the mono voice object 701 and the ambience MASA channel 703. This may be implemented as a ‘near-far’ stereo configuration. There is however the difference that the ‘near’ signal in these embodiments is a full mono voice object with parameters described for example as shown in the above tables.

In these embodiments the previously defined methods are extended to deal with immersive audio rather than stereo only and also various levels of rendering. The ‘far’ channel is the mono part of the mono-based MASA representation. Thus, it includes the full spatial ambience, but no actual way to render it correctly in space. What is rendered in case of stereo transport will depend also on the spatial rendering settings and capabilities. The following table provides some additional properties for the ‘far’ channel that may be used in rendering according to some embodiments.

| Property | Description (value) |
|---|---|
| Metadata: | Ambience position preference in two- |
| rendering | channel rendering (e.g., L/R, L/R/no- |
| channel | preference, L/R/both, L/R/both/no- |
| | preference). |
| | Property is intended for following intended |
| | rendering of the near-far stereo |
| | transmission. |
| | Property is similar to corresponding ‘near’ |
| | channel property. It is thus not necessary |
| | in all implementations as the ‘far’ channel |
| | always relates to a ‘near’ channel, which |
| | typically has a rendering channel |
| | preference information. Hence, the ‘far’ |
| | channel rendering channel preference |
| | may be considered simply as the opposite |
| | of the ‘near’ channel preference. |
| Metadata: | Ambience position preference in two- |
| rendering | channel rendering indicated as balance |
| balance | value (i.e., a preferred balance between L |
| | and R). |
| | Property is intended for following intended |
| | rendering of the near-far stereo transmission. |
| Metadata: | Time/duration in rendering to move the |
| panning | content from the transmitted “L” channel to |
| coefficient | rendered “R” channel and vice versa. After |
| | panning (L-to-R/R-to-L switching) is |
| | performed, the current state can be |
| | maintained until next panning coefficient |
| | update or switch to a lower/higher spatial |
| | dimension. |
| Metadata: | Indicates default/intended ambience |
| mixing | signal mixing level for combining near-far |
| balance | stereo signals in mono playback. |
| | Property is intended for following intended |
| | rendering of the near-far stereo/spatial |
| | MASA transmission in mono playback. |

The third and highest level of the embedded structure as shown by the Spatial audio column is the spatial audio representation that includes the mono voice object 701 and spatial MASA ambience representation including both the ambience MASA channel 703 and ambience MASA spatial metadata 705. In these embodiments the spatial information is provided in such a manner that it is possible to correctly render the ambience in space for the listener.

In addition, in some embodiments as shown by the spatial audio+objects column in FIG. 7 there can be included additional objects 707 in case of combined inputs to the encoder. It is noted that these additional separate objects 707 are not assumed to be part of the embedded encoding, rather they are treated separately.

In some embodiments, there may be priority signalling at the codec input (e.g., input metadata) indicating, e.g., whether a specific object 707 is more important or less important than the ambience audio. Typically, such information would be based on user input (e.g., via UI) or a service setting.

There may be, for example priority signalling that results in the lower embedded modes to include separate objects on the side before stepping to next embedded level for transmission.

In other words, under some circumstances (input settings) and operation points, the lower embedded modes and optional objects may be delivered, e.g., the mono voice object+separate audio object before it is considered switching to near-far stereo transmission mode.

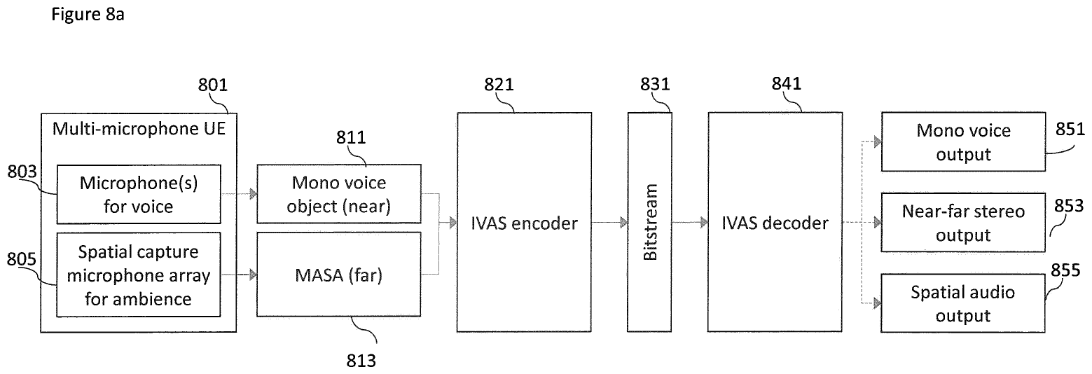

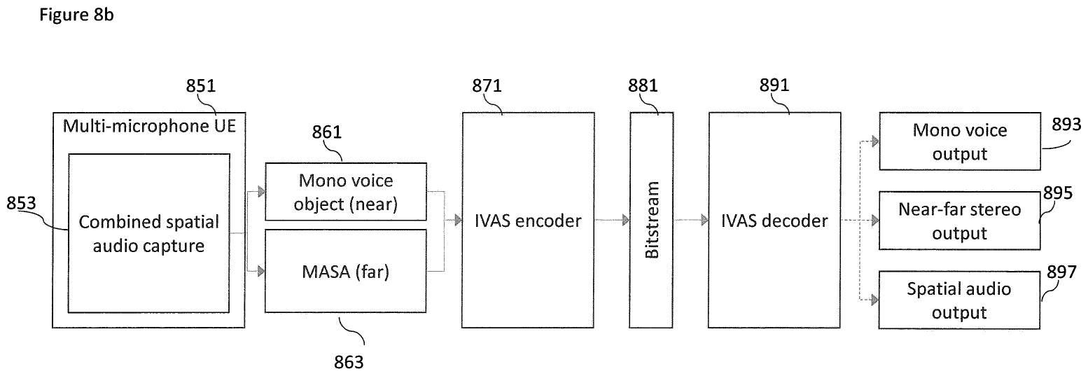

FIG. 8a presents an example apparatus for implementing some embodiments. FIG. 8a for example shows a UE 801. The UE 801 comprises at least one microphone for capturing a voice 803 of the user and is configured to provide the mono voice audio signal to the mono voice object (near) input 811. In other words the mono voice object is captured using a dedicated microphone setup.

For example, it can be a single microphone or more than one microphones that are used, e.g., to perform a suitable beamforming.

In some embodiments the UE 801 comprises a spatial capture microphone array for ambience 805 configured to capture the ambience components and pass these to a MASA (far) input 813.

The mono voice object (near) 811 input is in some embodiments configured to receive the microphone for voice audio signal and pass the mono audio signal as a mono voice object to the IVAS encoder 821. In some embodiments the mono voice object (near) 811 input is configured to process the audio signals (for example to optimise the audio signals for the mono voice object before passing the audio signals to the IVAS encoder 821.

The MASA input 813 is configured to receive the spatial capture microphone array for ambience audio signals and pass these to the IVAS encoder 821. In some embodiments the separate spatial capture microphone array is used to obtain the spatial ambience signal (MASA) and process them according to any suitable means to improve the quality of the captured audio signals.

The IVAS encoder 821 is then configured to encode the audio signals based on the two input format audio signals as shown by the bitstream 831.

Furthermore the IVAS decoder 841 is configured to decode the encoded audio signals and pass them to a mono voice output 851, a near-far stereo output 853 and to a spatial audio output 855.

FIG. 8b presents a further example apparatus for implementing some embodiments. FIG. 8b for example shows a UE 851 which comprises a combined spatial audio capture multi-microphone arrangement 853 which is configured to supply a mono voice audio signal to the mono voice object (near) input 861 and a MASA audio signal to a MASA input 863. In other words FIG. 8b shows a combined spatial audio capture that outputs a mono channel for voice and a spatial signal for the ambience. The combined analysis processing can, e.g., suppress the user voice from the spatial capture. This can be done for the individual channels or the MASA waveform (the ‘far’ channel). It can be considered that the audio capture appears very much like FIG. 8a, however there is at least some common processing, e.g., the beamformed microphone signal is removed from the spatial capture signals.

The mono voice object (near) 861 input is in some embodiments configured to receive the microphone for voice audio signal and pass the mono audio signal as a mono voice object to the IVAS encoder 871. In some embodiments the mono voice object (near) 861 input is configured to process the audio signals (for example to optimise the audio signals for the mono voice object before passing the audio signals to the IVAS encoder 871.

The MASA input 863 is configured to receive the spatial capture microphone array for ambience audio signals and pass these to the IVAS encoder 871. In some embodiments the separate spatial capture microphone array is used to obtain the spatial ambience signal (MASA) and process them according to any suitable means to improve the quality of the captured audio signals.

The IVAS encoder 871 is then configured to encode the audio signals based on the two input format audio signals as shown by the bitstream 881.

Furthermore the IVAS decoder 891 is configured to decode the encoded audio signals and pass them to a mono voice output 893, a near-far stereo output 895 and to a spatial audio output 897.

In some embodiments other spatial audio processing can be applied to optimize for the mono voice object+MASA spatial audio input than a suppression (removal) of the user voice from the individual channels or the MASA waveform can be used. For example, during active speech directions may not be considered corresponding to the main microphone direction or increasing the diffuseness values across the board. When the local VAD, for example, does not activate for the voice microphone(s), a full spatial analysis can be carried out. Such additional processing can in some embodiments be utilized, e.g., only when the UE is used over the ear or in hand-held hands-free operation with the microphone for voice signal close to the user's mouth.

For a multi-microphone IVAS UE a default capture mode can be one which utilizes the mono voice object+MASA spatial audio input format.

In some embodiments, the UE determines the capture mode based on other (non-audio) sensor information. For example, there may be known methods to detect that UE is in contact with or located substantially near to a user's ear. In this case, the spatial audio capture may enter the mode described above. In other embodiments, the mode may depend on some other mode selection (e.g., a user may provide an input using a suitable UI to select whether the device is in a hands-free mode, a handheld hands-free mode, or a handheld mode).

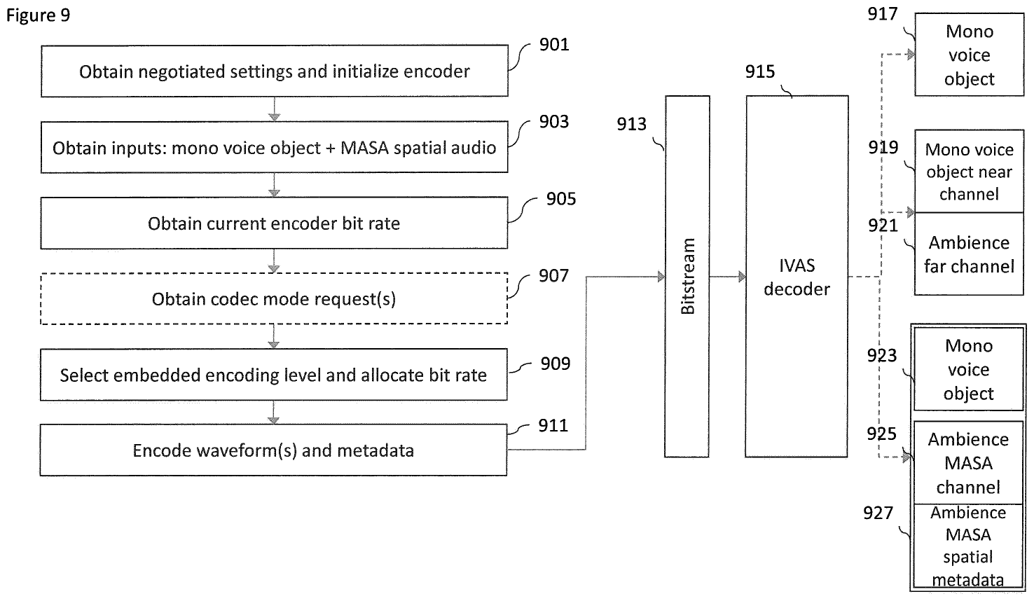

With respect to FIG. 9 the operations of the IVAS encoder 813, 863 are described in further detail.

For example the IVAS encoder 813, 863 may be configured in some embodiments to obtain negotiated settings (for example the mode as described above) and initialize the encoder as shown in FIG. 9 by step 901.

The next operation may be one of obtaining inputs. For example obtaining the mono voice object+MASA spatial audio as shown in FIG. 9 by step 903.

Also in some embodiments the encoder is configured to obtain a current encoder bit rate as shown in FIG. 9 by step 905.

The codec mode request(s) can then be obtained as shown in FIG. 9 by step 907. Such requests relate to a recipient request, e.g., for a specific encoding mode to be used by the transmitting device.

The embedded encoding level can then be selected and the bit rate allocated as shown in FIG. 9 by step 909.

Then the waveform(s) and the metadata can be encoded as shown in FIG. 9 by step 911.

Furthermore as shown in FIG. 9 is shown the output of the encoder is passed as the bitstream 913, which is then decoded by the IVAS decoder 915 this may for example be in the form of the embedded output form. For example in some embodiments the output form may be mono voice object 917. The mono voice object may further be a mono voice object near channel 919 with a further ambience far channel 921. Furthermore the output of the IVAS decoder 915 may be the mono voice object 923, ambience MASA channel 925 and ambience MASA channel spatial metadata 927.

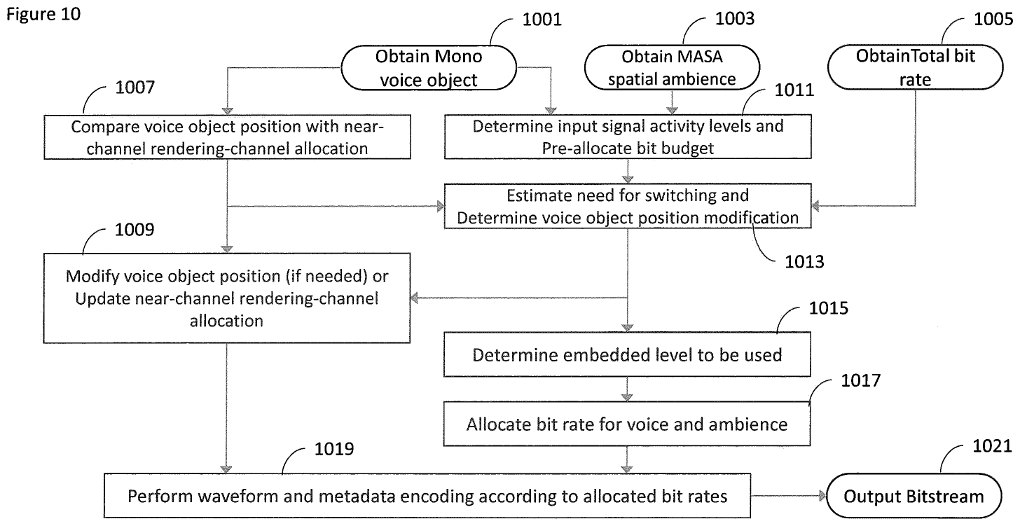

FIG. 10 furthermore shows in further detail the operations of selecting the embedded encoding level selection (FIG. 9 step 909) and the encoding of the waveform and metadata (FIG. 9 step 911). The initial operations are the obtaining of the mono voice object audio signals as shown in FIG. 10 by step 1001, the obtaining of the MASA spatial ambience audio signals as shown in FIG. 10 by step 1003 and the obtaining of the total bit rate as shown in FIG. 10 by step 1005.

Having obtained the mono voice object audio signals the method may then comprise comparing voice object positions with near channel rendering-channel allocations as shown in FIG. 10 by step 1007.

Furthermore having obtained the mono voice object audio signals and the MASA spatial ambience audio signals then the method may comprise determining input signal activity level and pre-allocating a bit budget as shown in FIG. 10 by step 1011.

Having compared the voice object positions, determined the input signal activity levels and obtained the total bit rate then the method may comprise estimating the need for switching and determining voice object position modification as shown in FIG. 10 by step 1013.

Having estimated the need for switching and determining voice object position modification the method may comprise modifying voice object positions when needed or updating near-channel rendering-channel allocation as shown in FIG. 10 by step 1009. In particular, it is considered for the embedded mode switching a modification of the mono voice object position to smooth any potential discontinuities. Alternatively, the recommended L/R allocation (as received at encoder input) for the near channel may be updated. This update may also include an update of the far channel L/R allocation (or, e.g., a mixing balance). The potential need for such modification is based on the possibility that the near-far stereo rendering channel preference and the voice object position significantly deviate. This deviation is possible, because the voice object position can be understood as a continuous time-varying position in the space. The near-far stereo channel selection (into L or R channel/ear presentation), on the other hand, is typically static or updated only, e.g., during certain pauses in order to not create unnecessary and annoying discontinuities (i.e., content jumps between channels). Therefore, it is tracked the signal activity levels of the two component waveforms.

Furthermore the method may comprise determining the embedded level to be used as shown in FIG. 10 by step 1015. This can be based on knowledge of total bit rate (and, e.g., negotiated bit rate range), it is estimated the potential need for switching of the embedded level being used (mono, stereo, spatial such as shown in FIGS. 7 and 9).

After this the bit rates for voice and ambience can then be allocated as shown in FIG. 10 by step 1017.

Having allocated the bit rates and modifying voice object positions when needed or updating near-channel rendering-channel allocation then the method may comprise performing waveform and metadata encoding according to allocated bit rates as shown in FIG. 10 by step 1019.

The encoded bitstream may then be output as shown in Figure by step 1021.

In some embodiments the encoder is configured to be EVS compatible. In such embodiments the IVAS codec may encode the user voice object in an EVS compatible coding mode (e.g. EVS 16.4 kbps). This makes compatibility to legacy EVS devices very straightforward, by stripping away any IVAS voice object metadata and spatial audio parts and decoding only the EVS compatible mono audio. This then corresponds with the end-to-end experience from EVS UE to EVS UE, although IVAS UE (with immersive capture) to EVS UE is used.

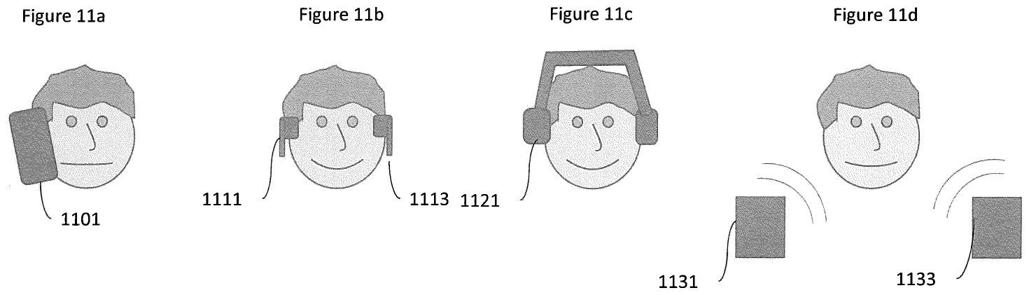

FIGS. 11a to 11d show some typical rendering/presentation use cases for immersive conversational services using IVAS which may be employed according to some embodiments. Although in some embodiments the apparatus may be configured to implement a conferencing application in the following discussion the apparatus and methods implement a (immersive) voice call, in other words, a call between two people. Thus for example the user may be configured to employ as shown in FIG. 11a a UE for audio rendering. In some embodiments where this is a legacy UE, a mono EVS encoding (or, e.g., AMR-WB) would typically have been negotiated. However, where the UE is an IVAS UE, it could be configured to receive an immersive bitstream. In such embodiments a mono audio signal playback is usually implemented, and therefore the user may playback the mono voice object only (and indeed only transmitted the mono voice object). In some embodiments an option can be provided for the user for selecting the output embedding level. For example the UE may be configured with a user interface (UI) which enables the user to control the level of ambience reproduction. Thus, in some embodiments a monaural mix of the near and far channels could also be provided and presented to the user. In some embodiments, a default mixing balance value is received based on the far channel properties table shown above. In some embodiments a mono voice default distance gain can be provided for example with respect to the additional/alternative voice object properties table also shown above.

In some embodiments the rendering apparatus comprise earbuds (such as shown by the wireless left channel earbud 1113 and right channel earbud 1111 in FIG. 11b) or headphones/headsets (such as shown by the wireless headphones 1121 in FIG. 11c) can be configured to provide typical immersive presentation use cases. In this embodiments case, a stereo audio signal or the full spatial audio signal can be presented to the user. Thus in some embodiments and depending on the bit rate, the spatial audio could in various embodiments comprise the mono voice object+MASA spatial audio representation (as provided at the encoder input) or a MASA only (where the talker voice has been downmixed into MASA). According to some embodiments a mono voice object, a near-far stereo, or the mono voice object+MASA spatial audio can be received by the user.

In some embodiments the rendering apparatus comprises stereo or multichannel speakers (as shown by the left channel speaker 1133 and right channel speaker 1131 shown in FIG. 11d) and the listener or receiving user is configured to listen to the call using the (stereo) speakers. This for example may be a pure stereo playback. In addition, the speaker arrangement may be a multi-channel arrangement such as 5.1 or 7.1+4 or any suitable configuration. Furthermore, a spatial loudspeaker presentation may be synthesized or implemented by a suitable soundbar playback device. In some embodiments where the rendering apparatus comprises stereo speakers then any spatial component received by the user device can be ignored. Instead, the playback can be the near-far stereo format. It is understood the near-far stereo can be configured to provide the capacity to play back the two signals discretely or at least one of the signals could be panned (for example according to metadata provided based on the tables shown above). Thus in some embodiments at least one of the playback channels may be a mix of the two discrete (near and far) transport channels.

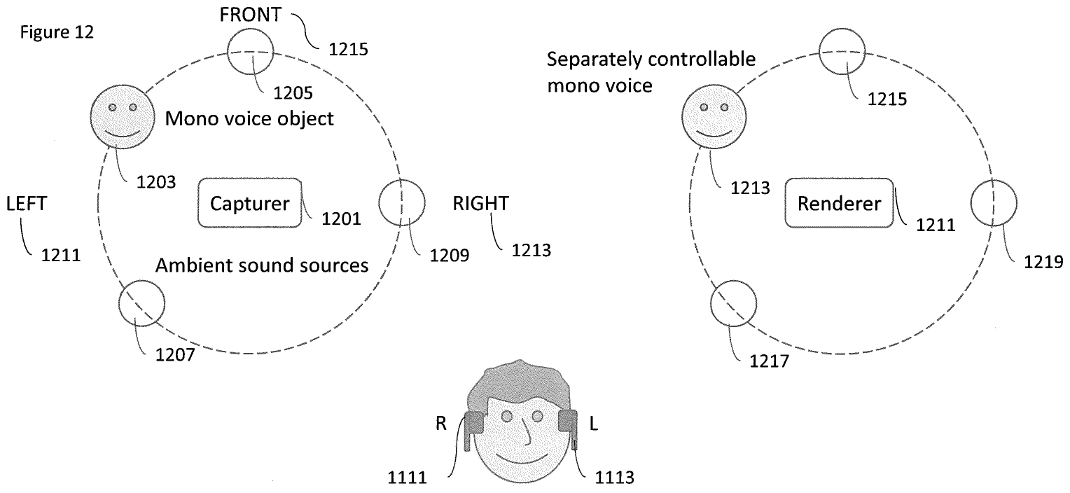

FIG. 12 illustrates an example of an immersive rendering of a ‘voice object+MASA ambience’ audio for stereo headphone/earbud/earpod presentation (visualized here for a user wearing left channel 1113 and right channel 1111 earpods). The capture scene is shown with orientations, front 1215, left 1211 and right 1213 and the scene comprising the capture apparatus 1201, the mono voice object 1203 located between the front and left orientations, and ambient sound sources. In the example shown in FIG. 12 is shown a source 1 1205 located to the front of the capture apparatus 1201, source 2 1209 located to the right of the capture apparatus 1201, and source 3 1207 located between the left and rear of the capture apparatus 1201. The renderer 1211 (listener) is able, by using embodiments as described herein, to generate and present a facsimile of the capture scene. For example the renderer 1211 is configured to generate and present the mono voice object 1213 located between the front and left orientations, and ambient sound source 1 1215 located to the front of the render apparatus 1211, source 2 1219 located to the right of the render apparatus 1211, and source 3 1217 located between the left and rear of the render apparatus 1211. In such a manner the receiving user is presented an immersive audio scene according to the input representation. The voice stream can furthermore be separately controlled relative to the ambience, e.g., the volume level of the talker can be made louder or the talker position can be manipulated on a suitable UE UI.

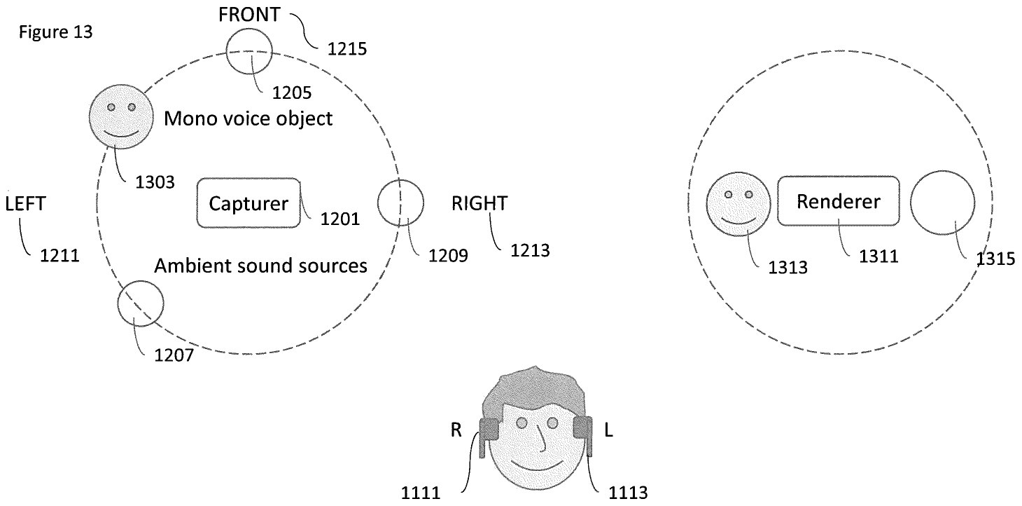

FIG. 13 illustrates the change in rendering under bit rate switching (where the embedded level drops) according to an example near-far representation. Here, the presented voice object position 1313 and near-far rendering channel information match (i.e., user voice is rendered on default left channel that corresponds to general voice object position relative to listening position). The ambience is then mixed to the right channel 1315. This can generally be achieved using the system as shown in FIG. 10.

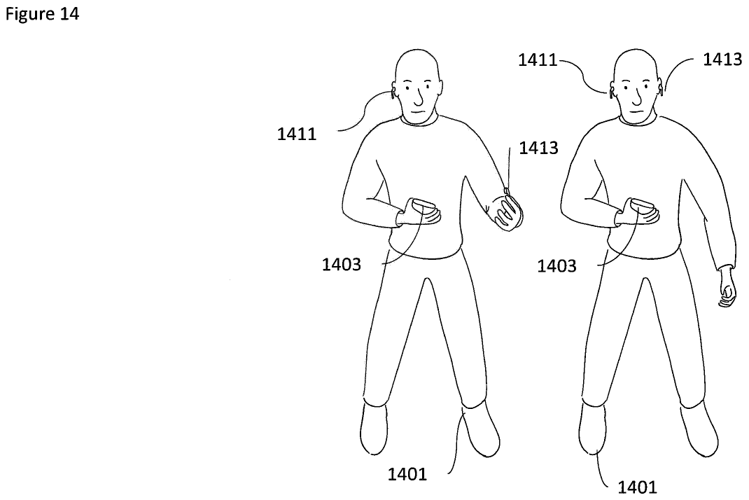

FIG. 14 illustrates a presentation-capability switching use case. While there can be many other examples, the earpod use case is foreseen as common capability switching for currently available devices. The earpod form factor is growing in popularity and is likely to be very relevant for IVAS audio presentation in both user-generated content (UGC) and conversational use cases. Furthermore, it can be expected that headtracking capability will be implemented in this form factor in upcoming years. The form factor is thus natural candidate for device that is used across all of the embedded immersion levels: mono, stereo, spatial.

In this example, we have a user 1401 on the receiving end of an immersive IVAS call. The user 1401 has a UE 1403 in their hand, and the UE is used for audio capture (which may be an immersive audio capture). For rendering the incoming audio, the UE 1403 connects to smart earpods 1413, 1411 that can be operated individually or together. The wireless earpods 1413, 1411 thus act as a mono or stereo playback device depending on user preference and behaviour. The earpods 1413, 1411 can, for example in some embodiments feature automatic detection of whether they are placed in the user's ear or not. On left-hand side of FIG. 14, it is illustrated user wearing a single earpod 1411. However, the user may add a second one 1413, and on the right-hand side of FIG. 14 we illustrate the user wearing both earpods 1413, 1411. It is thus possible for a user to, e.g., switch repeatedly during a call between two-channel stereo (or immersive) playback and one-channel mono playback. In some embodiments the immersive conversational codec renderer is able to deal with this use case by providing a consistently good user experience. Otherwise, the user would be distracted by the incorrect rendering of the incoming communications audio and could, e.g., lose the transmitting user voice altogether.

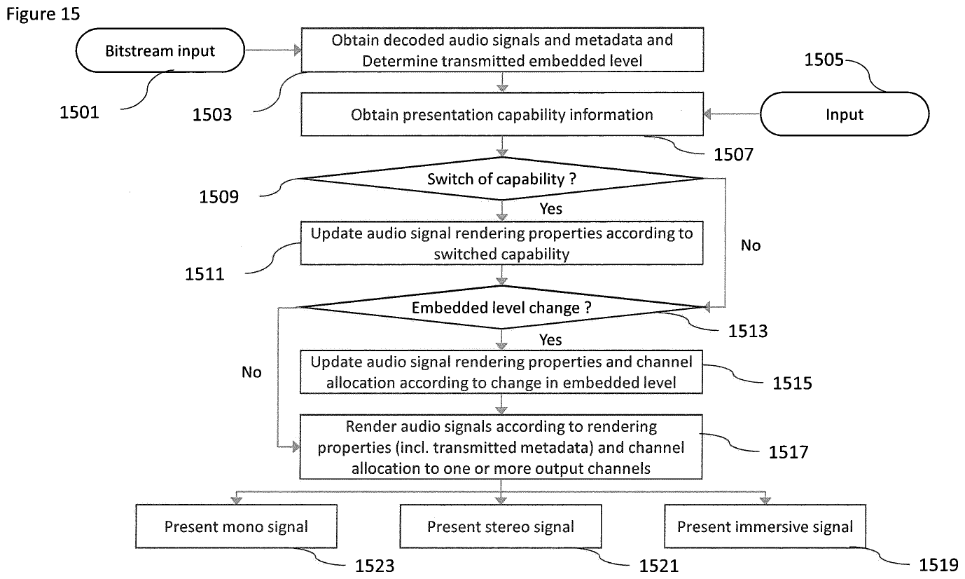

With respect to FIG. 15 is shown a flow diagram of a suitable method for controlling the rendering according to presentation-capability switching in the decoder/renderer. The rendering control can in some embodiment be implemented as part of at least one of: (IVAS) internal renderer and external renderer.

Thus in some embodiments the method comprises receiving the bitstream input as shown in FIG. 15 by step 1501.

Having received the bitstream the method may further comprise obtaining the decoded audio signals and metadata and determining the transmitted embedded level as shown in FIG. 15 by step 1503.

Furthermore the method may further comprise receiving a suitable user interface input as shown in FIG. 15 by step 1505.

Having obtained the suitable user interface input and obtained the decoded audio signals and metadata and determined the transmitted embedded level then the method may comprise obtaining presentation capability information as shown in FIG. 15 by step 1507.

The following operation is one of determining where there is a switch of capability as show in FIG. 15 by step 1509.

Where a switch of capability is determined then the method may comprise updating audio signal rendering properties according to the switched capability as shown in FIG. 15 by step 1511.

Where there was no switch or following the updating then the method may comprise determining whether there is an embedded level change as shown in FIG. 15 by step 1513.

Where there is an embedded level change then the method may comprise updating the audio signal rendering properties and channel allocation according to change in embedded level as shown in FIG. 15 by step 1515.

Where there was no embedded level change or following the updating of the audio signal rendering properties and channel allocation then the method may comprise rendering the audio signals according to the rendering properties (including the transmitted metadata) and channel allocation to one or more output channels as shown in FIG. 15 by step 1517.

This rendering may thus result in the presentation of the mono signal as shown in FIG. 15 by step 1523, the presentation of the stereo signal as shown in FIG. 15 by step 1521 and the presentation of the immersive signal as shown in FIG. 15 by step 1519.

Thus modifications for the voice object can be applied and ambience signal rendering under presentation-capability switching and embedded-level changes can be implemented.

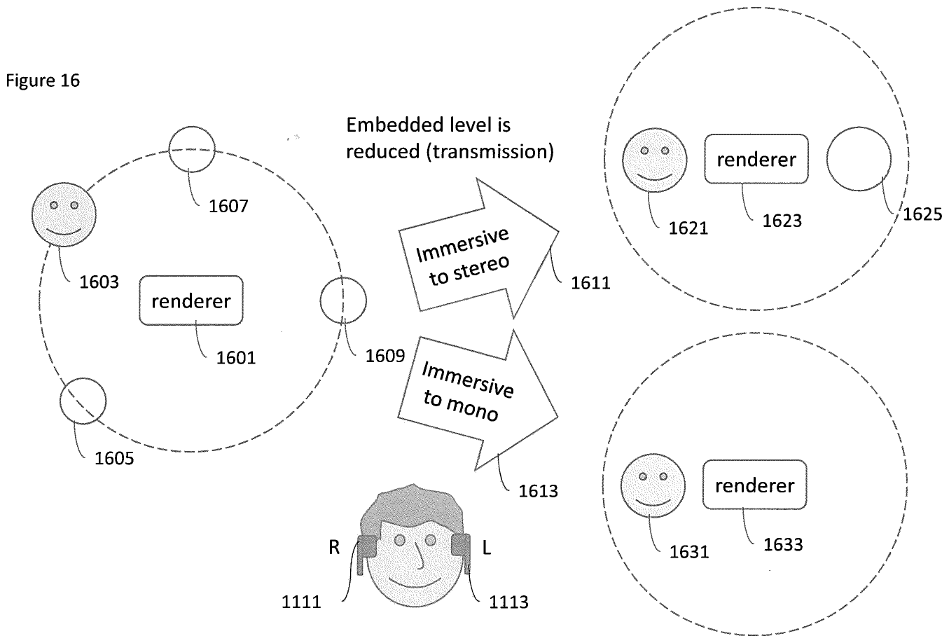

Thus for example with respect to FIG. 16 is shown rendering control during a default embedded level changing from immersive embedded level to either stereo embedded level or directly to mono embedded level. For example, network congestion results in reduced bit rate, and the encoder changes the embedded level accordingly. In the example on the left hand side of an immersive rendering of a ‘voice object+MASA ambience’ audio for stereo headphone/earbud/earpod presentation (visualized here for a user wearing left channel 1113 and right channel 1111 earpods). The presented scene is shown comprising the renderer 1601, the mono voice object 1603 located between the front and left orientations, and ambient sound sources, source 1 1607 located to the front of the renderer apparatus 1601, source 2 1609 located to the right of the renderer apparatus 1601, and source 3 1605 located between the left and rear of the renderer apparatus 1601.

The embedded level is reduced as shown by the arrow 1611 from immersive to stereo which results in the mono voice object 1621 being rendered by the left channel and ambient sound sources located to the right of the renderer apparatus 1625.

The embedded level is also shown reduced as shown by the arrow 1613 from immersive to mono which results in the mono voice object 1631 being rendered by the left channel. In other words when the user is listening in stereo presentation the stereo and mono signals are not binauralized. Rather, the signalling is taken into account and the presentation side of the talker voice (voice object preferred channel according to encoder signalling) is selected.

In some embodiments where a “smart” presentation device is able to signal its current capability/usage to the (IVAS internal/external) renderer, the renderer may be able to determine the capability for a mono or a stereo presentation and furthermore the channel (or which ear) the mono presentation is possible. If this is not known or determinable it is up to the user to make sure their earpods/headphones/earphones etc are correctly placed otherwise the user may (in case of spatial presentation) receive an incorrectly rotated immersive scene or (depending on the renderer) be provided ambience presentation that is mostly diffuse.

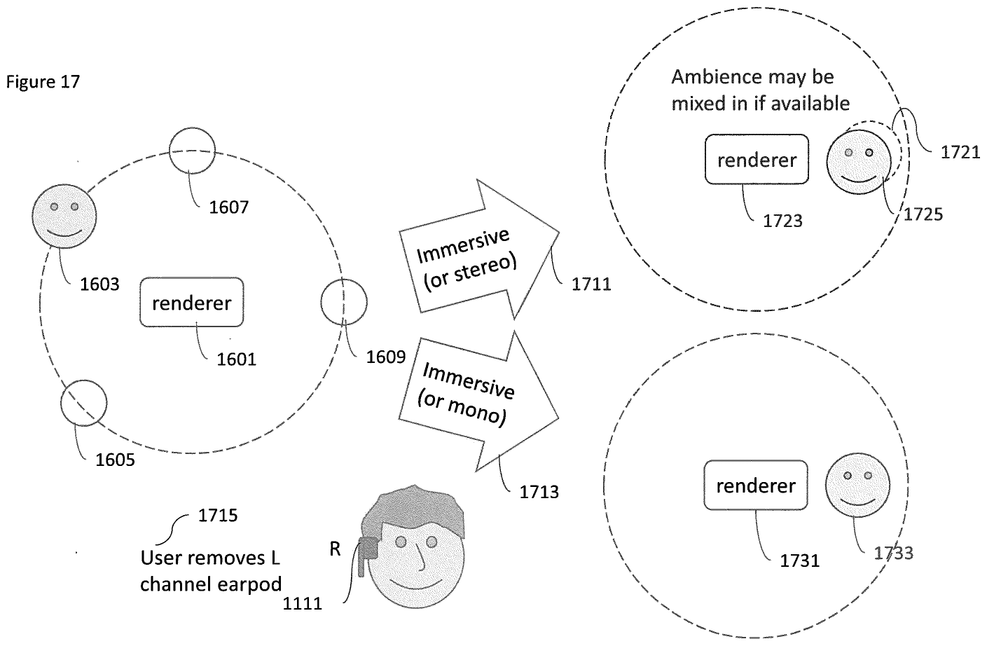

This may for example be shown with respect to FIG. 17 which illustrates rendering control during a capacity switching from two to one channel presentation. Here, it is thus understood the decoder/renderer is configured to receive indication of capacity change. This for example may be the input step 1505 shown in the flow diagram of FIG. 15.

FIG. 17 for example shows a similar scene as shown in FIG. 16 but where the user removes or switches off 1715 the left channel earpod resulting in only the right channel earpod 1111 being worn. As such as shown on the left hand side there is shown the presented scene is shown comprising the renderer 1601, the mono voice object 1603 located between the front and left orientations, and ambient sound sources, source 1 1607 located to the front of the renderer apparatus 1601, source 2 1609 located to the right of the renderer apparatus 1601, and source 3 1605 located between the left and rear of the renderer apparatus 1601.

The embedded level is reduced as shown by the arrow 1711 from immersive to stereo which results in the mono voice object 1725 being rendered by the right channel and ambient sound sources 1721 also being located to the right of the renderer apparatus 1725.

The embedded level is also shown reduced as shown by the arrow 1713 from immersive to mono which results in the mono voice object 1733 being rendered by the right channel.

In such embodiments an immersive signal can be received (or there is a substantially simultaneous embedded level change to stereo or mono, this could be caused, e.g., by a codec mode request (CMR) to encoder based on receiver presentation device capability change). The audio is thus routed to the available channel in the renderer. Note that this is a renderer control, it is not merely downmixed in the presentation device the two channels, which would be a direct downmix of the immersive signal seen on the left-hand side of FIG. 17, if there is only presentation-capability switching and no change in embedded layer level. The user experience is therefore improved with better clarity of the voice.

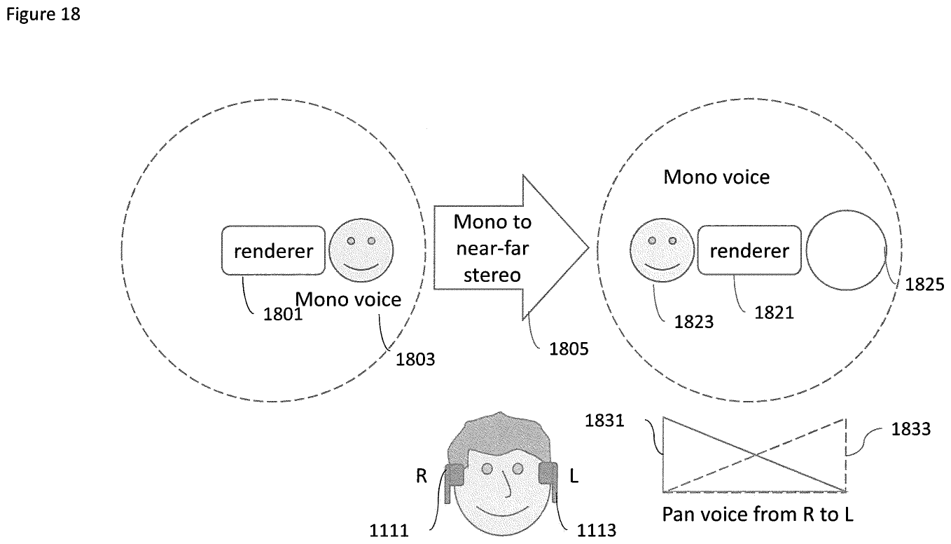

With respect to FIG. 18 is shown an example of embedded level change from mono to stereo. The left hand side shows that with respect to the renderer the mono voice object 1803 position is on the right of the renderer 1801. When the mono to near-far stereo capability is changed (based on encoder signalling or associated user preference at decoder) then the voice is panned from the right to the left side as shown by profiles 1833 (right profile) to 1831 (left profile) resulting in the object renderer outputting the voice object (near) 1823 to the left and the ambient (far) 1825 to the right.

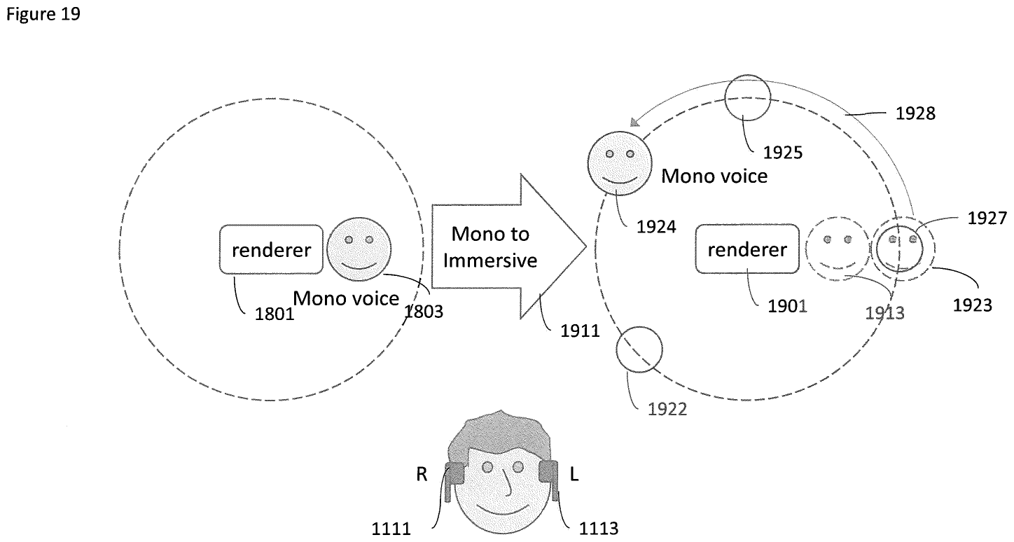

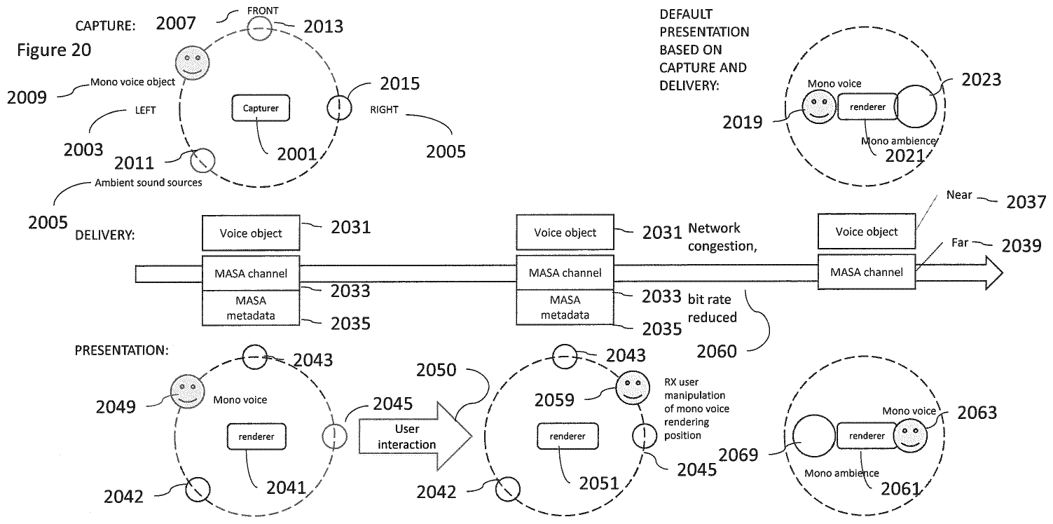

With respect to FIG. 19 is shown an example of embedded level change from mono to immersive. The left hand side shows that with respect to the renderer the mono voice object 1803 position is on the right of the renderer 1801. When the mono to immersive capability is changed (e.g., it is allocated a higher bit rate), the mono voice object is smoothly transferred 1928 to its correct position 1924 in the spatial scene. This is possible, because it is delivered separately. It is thus modified the position metadata (in the decoder/renderer) to achieve this transition. (If there is no externalization/binauralization initially in the mono rendering, the voice object becomes firstly externalized from 1913 to 1923 as illustrated. Additionally the ambient audio sources 1922, 1925, 1927 are presented in their correct positions.

With respect to FIG. 20 illustrates an example presentation adaptation for a lower spatial dimension audio based on a previous user interaction by the receiving user (at higher spatial dimension). It is illustrated the capture of the spatial scene and its default presentation in near-far stereo mode.

Thus FIG. 20 shows a capture and immersive rendering of a ‘voice object 2031+MASA ambience (MASA channel 2033 and MASA metadata 2035)’ audio. The capture scene is shown with orientations, front 2013, left 2003 and right 2015 and the scene comprising the capture apparatus 2001, the mono voice object 2009 located between the front and left orientations, and ambient sound sources. In the example shown in FIG. 20 is shown a source 1 2013 located to the front of the capture apparatus 2001, source 2 2015 located to the right of the capture apparatus 2001, and source 3 2011 located between the left and rear of the capture apparatus 1201. The renderer 2041 (listener) is able, by using embodiments as described herein, to generate and present a facsimile of the capture scene. For example the renderer 2041 is configured to generate and present the mono voice object 2049 located between the front and left orientations, and ambient sound source 1 2043 located to the front of the render apparatus 2041, source 2 2045 located to the right of the render apparatus 2041, and source 3 3042 located between the left and rear of the render apparatus 1211.

The receiving user furthermore has the freedom to manipulate at least some aspects of the scene (according to any signalling that could limit the user's freedom to do so). The user for example may move the voice object to a position they prefer as shown by the arrow 2050. This may trigger in the application a remapping of the local preference for voice channel. The renderer 2051 (listener) is thus able, by using embodiments as described herein, to generate and present a modified facsimile of the capture scene. For example the renderer 2051 is configured to generate and present the mono voice object 2059 located between the front and right orientations, while maintaining the ambient sound sources 2042, 2043, 2045 at their original orientations.

Furthermore when the embedded layer level changes for example caused by network congestion/reduced bit rate etc 2060 then the mono voice object 2063 is kept by the render apparatus 2061 on the channel it was previously predominantly heard by the user and the mono ambience audio object 2069 on the other side. (Note that in the binauralized presentation the user hears the voice from both channels. It is the application of the HRTFs and the direction of arrival of the voice object that gives it its position in the virtual scene. In case of the non-binauralized presentation of the stereo signal, the voice can alternatively appear from a single channel only.) This differs from the default situation based on the capture and delivery as shown on the top right where the then the mono voice object 2019 is located by the render apparatus 2021 on the original side of capture and the mono ambience audio object 2023 opposite.

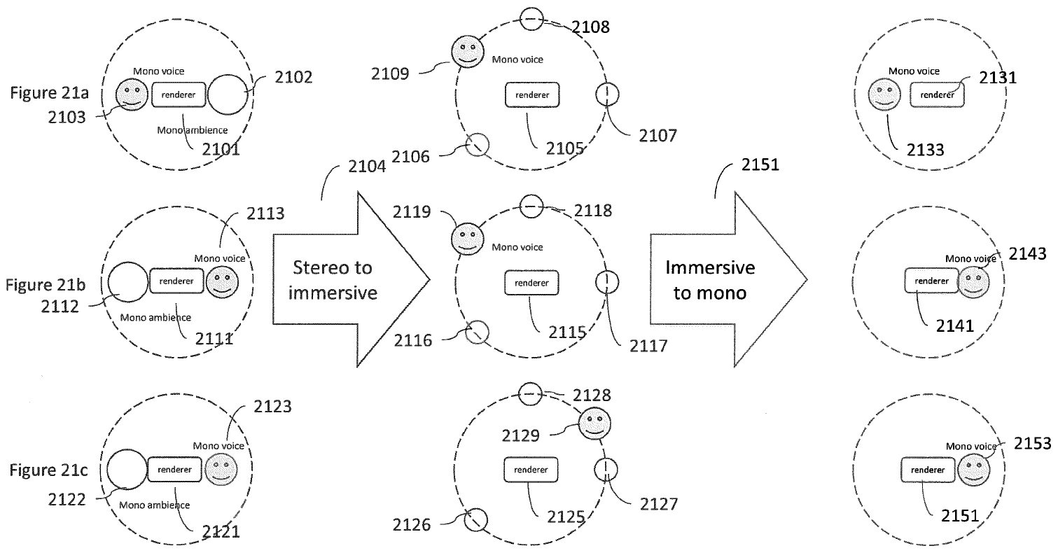

With respect to FIG. 21 is shown a comparison of three user experiences according to the embodiments. These are all controlled by the encoder or the decoder/renderer side signalling. It is presented three states of the same scene (for example the scene as described previously with respect to FIG. 12), where the states are transitioned and where the difference is implemented within the rendering control. In the top panel FIG. 21a, it is shown the presentation according to encoder-side signalling. Thus initially the renderer 2101 is configured with a mono voice source 2103 to the left and mono ambience audio source 2102 to the right. A stereo to immersive transition 2104 results in the renderer 2105 with a mono voice source 2109 and ambient audio sources 2106, 2107, 2108 in the correct position. A further immersive to mono transition results in the renderer 2131 with a mono voice source 2133 on the left.

In the middle panel FIG. 21b, it is shown the presentation according to a combination of the encoder-side and decoder/renderer-side signalling. Here, the user has the preference of having the voice object in the R channel (e.g., right ear). FIG. 21a, it is shown the presentation according to encoder-side signalling. Thus initially the renderer 2111 is configured with a mono voice source 2113 to the right and mono ambience audio source 2112 to the left. A stereo to immersive transition 2104 results in the renderer 2115 with a mono voice source 2119 and ambient audio sources 2116, 2117, 2118 in their correct positions. A further immersive to mono transition results in the renderer 2141 with a mono voice source 2143 on the right.

Finally, the bottom panel FIG. 21c illustrates how a user-preference is applied also the immersive scene. This may be the case, e.g., as here where there is a first transition from a near-far stereo transmission (and its presentation according to user preference) to the immersive scene transmission. It is adapted the voice object position to maintain the user preference. Thus initially the renderer 2121 is configured with a mono voice source 2123 to the right and mono ambience audio source 2122 to the left. A stereo to immersive transition 2104 results in the renderer 2125 with a mono voice source 2129 moved to a new position and ambient audio sources 2126, 2127, 2108 in the correct position. A further immersive to mono transition results in the renderer 2151 with a mono voice source 2153 on the left.

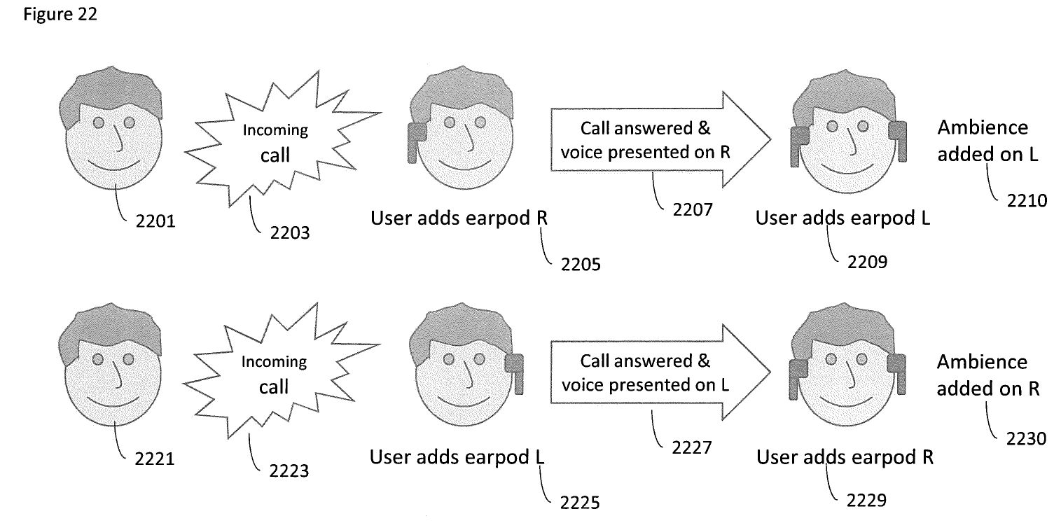

With respect to FIG. 22 is shown a channel preference selection (provided as decoder/renderer input) based on earpod activation by a receiving user. This is one example that can determine at least some of the user-preference states/inputs seen in some of the previous examples. For example, user may not have a preference as such. However, it is determined a pseudo-preference for the receiving user in order to maintain a stable scene rendering based on the channel selection by the user at time of receiving the call.

Thus for example the top panel shows a user 2201 with an incoming call 2203 (where the transmission utilizes, e.g., the near-far stereo configuration), the user adds the right channel earpod 2205, the call is answered and the voice presented on the right channel as shown in arrow 2207. The user may then furthermore add a left channel earpod 2209 which then causes the renderer to add the ambience on the left channel as shown by reference 2210.

The bottom panel shows a user 2221 with an incoming call 2223 (where the transmission utilizes, e.g., the near-far stereo configuration), the user adds the left channel earpod 2225, the call is answered and the voice presented on the left channel as shown in arrow 2227. The user may then furthermore add a right channel earpod 2229 which then causes the renderer to add the ambience on the right channel as shown by reference 2230.

It is understood that in many conversational immersive audio use cases it is not known by the receiving user what is the correct scene. As such, it is important to provide a high-quality and consistent experience, where the user is always delivered at least the most important signal(s). In general, for conversational use cases, the most important signal is the talker voice. Here, it is during capability switching maintained voice signal presentation. If needed, the voice signal thus switches from one channel to another or from one direction to a remaining channel. The ambience is automatically added or removed based on the presentation capability and signalling.

According to the embodiments herein, it is thus transmitted two possibly completely independent audio streams in an embedded spatial stereo configuration, where a first stereo channel is a mono voice and a second stereo channel is basis of a spatial audio ambience scene. For rendering, it is thus important to understand the intended or desired spatial meaning/positioning of the two channels at least in terms of the L-R channel placement. In other words, it is generally needed knowledge of which of near-far channels is L and which of them is R. Alternatively, as explained in embodiments, it can be provided information on desired ways to mix them together for rendering of at least one of the channels. For any backwards compatible playback, the channels can regardless be always played back as L and R (although the selection may then be arbitrary, e.g., by designating a first channel as L and a second channel as R).

Thus in some embodiments it can be decided based on mono/stereo capability signalling how to present any of the following received signals in a practical rendering system. These may include:
Mono voice object only (or mono signal only with metadata stripped)
Near-far stereo with mono voice object (or mono voice with metadata stripped) and mono ambient waveform
Spatial audio scene where the mono voice object is delivered separately

In case of mono-only playback, the default presentation may be straightforward:
Mono voice object is rendered in available channel
Near component (mono voice object) is rendered in available channel
Separately delivered mono voice object is rendered in available channel

In case of stereo playback, the default presentation is proposed as follows:
Mono voice object is rendered in preferred channel OR mono object is binauralized according to the signaled direction
Near component (mono voice object) is rendered in preferred channel with far component (mono ambient waveform) rendered in the second channel OR near component (mono voice object) is binauralized according to the signaled direction with far component (mono ambient waveform) binauralized according to default or user-preferred way
   The binauralization of the ambient signal may by default be fully diffuse or it may depend on the near channel direction or some previous state
Separately delivered mono voice object is binauralized according to the signaled direction with spatial ambience being binauralized according to MASA spatial metadata description

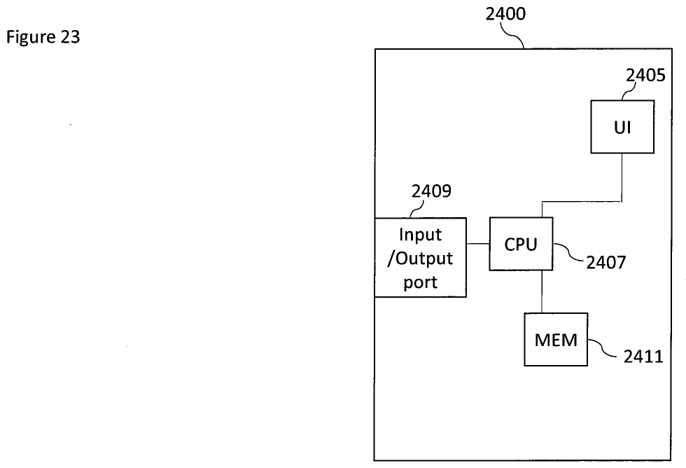

With respect to FIG. 23 an example electronic device which may be used as the analysis or synthesis device is shown. The device may be any suitable electronics device or apparatus. For example in some embodiments the device 2400 is a mobile device, user equipment, tablet computer, computer, audio playback apparatus, etc.

In some embodiments the device 2400 comprises at least one processor or central processing unit 2407. The processor 2407 can be configured to execute various program codes such as the methods such as described herein.

In some embodiments the device 2400 comprises a memory 2411. In some embodiments the at least one processor 2407 is coupled to the memory 2411. The memory 2411 can be any suitable storage means. In some embodiments the memory 2411 comprises a program code section for storing program codes implementable upon the processor 2407. Furthermore in some embodiments the memory 2411 can further comprise a stored data section for storing data, for example data that has been processed or to be processed in accordance with the embodiments as described herein. The implemented program code stored within the program code section and the data stored within the stored data section can be retrieved by the processor 2407 whenever needed via the memory-processor coupling.

In some embodiments the device 2400 comprises a user interface 2405. The user interface 2405 can be coupled in some embodiments to the processor 2407. In some embodiments the processor 2407 can control the operation of the user interface 2405 and receive inputs from the user interface 2405. In some embodiments the user interface 2405 can enable a user to input commands to the device 2400, for example via a keypad. In some embodiments the user interface 2405 can enable the user to obtain information from the device 2400. For example the user interface 2405 may comprise a display configured to display information from the device 2400 to the user. The user interface 2405 can in some embodiments comprise a touch screen or touch interface capable of both enabling information to be entered to the device 2400 and further displaying information to the user of the device 2400. In some embodiments the user interface 2405 may be the user interface as described herein.

In some embodiments the device 2400 comprises an input/output port 2409. The input/output port 2409 in some embodiments comprises a transceiver. The transceiver in such embodiments can be coupled to the processor 2407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The input/output port 2409 may be coupled to any suitable audio output for example to a multichannel speaker system and/or headphones (which may be a headtracked or a non-tracked headphones) or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus comprising:
at least one processor; and
at least one non-transitory memory including a computer program code,
the at least one memory and the computer program code configured to, with the at least one processor, cause the apparatus at least to:
receive at least one channel voice audio signal and metadata associated with the at least one channel voice audio signal, the at least one channel voice audio signal and metadata generated from at least one microphone audio signal;
receive at least one channel ambience audio signal and metadata associated with the at least one channel ambience audio signal, wherein the at least one channel ambience audio signal and metadata are generated based on an analysis of at least one microphone audio signal, and the at least one channel ambience audio signal is associated with the at least one channel voice audio signal; and
generate an encoded multichannel audio signal based on the at least one channel voice audio signal and metadata and further the at least one channel ambience audio signal and metadata, such that the encoded multichannel audio signal enables the spatial presentation of the at least one channel voice audio signal spatially independent of the at least one channel ambience audio signal.

2. The apparatus as claimed in claim 1, wherein the means is further configured apparatus is further caused to receive at least one further audio object audio signal, wherein the means configured to generate an generated encoded multichannel audio signal is configured to generate the encoded multichannel audio sig-nal further based on the at least one further audio object audio signal such that the encoded multichannel audio signal enables the spatial presentation of the at least one further audio object audio signal spatially independent of the at least one channel voice audio signal and the at least one channel ambience audio signal.

3. The apparatus as claimed in claim 1, wherein the at least one microphone audio signal from which is generated the at least one channel voice audio signal and metadata; and the at least one microphone audio signal from which is generated the at least one channel ambience audio signal and metadata comprise one of:
separate groups of microphones with no microphones in common; or
groups of microphones with at least one microphone in common.

4. The apparatus as claimed in claim 1, wherein the apparatus is further caused to receive an input configured to control the generation of the encoded multichannel audio signal.

5. The apparatus as claimed in claim 1, wherein the apparatus is further caused to modify a position parameter of the metadata associated with the at least one channel voice audio signal or change a near-channel rendering-channel allocation associated with the at least one channel voice audio signal based on a determined mismatch between the position parameter of the metadata associated with the at least one channel voice audio signal and an allocated near channel rendering-channel.

6. The apparatus as claimed in claim 1, wherein the generated encoded multichannel audio signal causes the apparatus to:
obtain an encoder bit rate;
select embedded coding levels and allocate a bit rate to each of the selected embedded coding levels, wherein a first level is associated with the at least one channel voice audio signal and metadata, a second level is associated with the at least one channel ambience audio signal, and a third level is associated with the metadata associated with the at least one channel ambience audio signal; and
encode at least one channel voice audio signal and metadata, the at least one channel ambience audio signal and metadata associated with the at least one channel ambience audio signal based on the allocated bit rates.

7. The apparatus as claimed in claim 1, wherein the apparatus is further caused to determine a capability parameter, the capability parameter being determined based on at least one of:
a transmission channel capacity; or
a rendering apparatus capacity, wherein the generated encoded multichannel audio signal is configured to generate an encoded multichannel audio signal further based on the capability parameter.

8. The apparatus as claimed in claim 7, wherein the generated encoded multichannel audio signal further based on the capability parameter is configured to select embedded coding levels and allocate a bit rate to each of the selected embedded coding levels based on at least one of the at least one of the transmission channel capacity or the rendering apparatus capacity.

9. The apparatus as claimed in claim 1, wherein the at least one microphone audio signal used to generate the at least one channel ambience audio signal and metadata based on a parametric analysis comprises at least two microphone audio signals.

10. The apparatus as claimed in claim 1, wherein the apparatus is further caused to output the encoded multichannel audio signal,

11. An apparatus comprising:
at least one processor; and
at least one non-transitory memory including a computer program code,
the at least one memory and the computer program code configured to, with the at least one processor, cause the apparatus at least to:
receive an embedded encoded audio signal, the embedded encoded audio signal comprising at least one of the following levels of embedded audio signal:
at least one channel voice audio signal and associated metadata to be rendered as a spatial voice scene;
at least one channel voice audio signal and associated metadata, and at least one channel ambience audio signal to be rendered as a near-far stereo scene; or
at least one channel voice audio signal and associated metadata, and at least one channel ambience audio signal and associated spatial metadata to be rendered as a spatial audio scene; and
decode the embedded encoded audio signal and output a multichannel audio signal representing the scene and such that the multichannel audio signal enables the spatial presentation of the at least one channel voice audio signal independent of the at least one channel ambience channel audio signal.

12. The apparatus as claimed in claim 11, wherein the levels of embedded audio signal further comprise at least one channel voice audio signal and associated metadata, and at least one channel ambience audio signal and associated spatial metadata to be rendered as a spatial audio scene and at least one further audio object audio signal and associated metadata and wherein the apparatus is caused to decode and output the multichannel audio signal representing the scene, such that the spatial presentation of the at least one further audio object audio signal is spatially independent of the at least one channel voice audio signal and the at least one channel ambience audio signal.

13. The apparatus as claimed in claim 11, wherein theapparatus is further caused to receive an input configured to control the decoding of the embedded encoded audio signal and output of the multichannel audio signal.

14. The apparatus as claimed in claim 13, wherein the input comprises a switch of capability, wherein the apparatus is caused to decode the embedded encoded audio signal and output the multichannel audio signal is configured to update the decoding and outputting based on the switch of capability.

15. The apparatus as claimed in claim 14, wherein the switch of capability comprises at least one of:
a determination of earbud/earphone configuration;
a determination of headphone configuration; or
a determination of speaker output configuration.

16. The apparatus as claimed in claim 13, wherein the input comprises at least one of:
a determination of a change of embedded level, wherein the apparatus is caused to decode the embedded encoded audio signal and output the multichannel audio signal is configured to update the decoding and outputting based on the change of embedded level; or
a determination of a change of bit rate for the embedded level, wherein the apparatus is caused to decode the embedded encoded audio signal and output the multichannel audio signal is configured to update the decoding and outputting based on the change of bit rate for the embedded level.

17. (canceled)

18. The apparatus as claimed in claim 13, wherein the apparatus is caused to control the decoding of the embedded encoded audio signal and output of the multichannel audio signal to modify at least one channel voice audio signal position or change a near-channel rendering-channel allocation associated with the at least one channel voice audio signal based on a determined mismatch between at least one voice audio signal detected position and/or an allocated near-channel rendering-channel channel.

19. The apparatus as claimed in claim 13, wherein the input comprises a determination of correlation between the at least one channel voice audio signal and the at least one channel ambience audio signal, and the apparatus is caused to decode and output the multichannel audio signal is configured to:
when the correlation is less than a determined threshold then:
control a position associated with the at least one channel voice audio signal, and
control an ambient spatial scene formed with the at least one channel ambience audio signal with rotating the ambient spatial scene, based on the at least one channel ambience audio signal, according to an obtained rotation parameter or compensating for a rotation of the further device with applying a corresponding opposite rotation to the ambient spatial scene; and when the correlation is greater than or equal to the determined threshold then:
control a position associated with the at least one channel voice audio signal, and
control an ambient spatial scene formed with the at least one channel ambience audio signal with compensating for a rotation of the further device with applying a corresponding opposite rotation to the ambient spatial scene while letting the rest of the scene rotate or rotating the ambient spatial scene, based on the at least one channel ambience audio signal, according to an obtained rotation parameter.

20-21. (canceled)

22. A method comprising:
receiving at least one channel voice audio signal and metadata associated with the at least one channel voice audio signal, the at least one channel voice audio signal and metadata generated from at least one microphone audio signal;
receiving at least one channel ambience audio signal and metadata associated with the at least one channel ambience audio signal, wherein the at least one channel ambience audio signal and metadata are generated based on an analysis of at least one microphone audio signal, and the at least one channel ambience audio signal is associated with the at least one channel voice audio signal; and
generating an encoded multichannel audio signal based on the at least one channel voice audio signal and metadata and further the at least one channel ambience audio signal and metadata, such that the encoded multichannel audio signal enables the spatial presentation of the at least one channel voice audio signal spatially independent of the at least one channel ambience audio signal.

23. A method comprising:
receiving an embedded encoded audio signal, the embedded encoded audio signal comprising at least one of the following levels of embedded audio signal:
at least one channel voice audio signal and associated metadata to be rendered as a spatial voice scene;
at least one channel voice audio signal and associated metadata, and at least one channel ambience audio signal to be rendered as a near-far stereo scene; or
at least one channel voice audio signal and associated metadata, and at least one channel ambience audio signal and associated spatial metadata to be rendered as a spatial audio scene; and
decoding the embedded encoded audio signal and output a multichannel audio signal representing the scene and such that the multichannel audio signal enables the spatial presentation of the at least one channel voice audio signal independent of the at least one channel ambience channel audio signal.
